(19) United States
(12) Patent Application Publication
(10) Pub. No.: US 2025/0034492 A1
(43) Pub. Date: Jan. 30, 2025

(54) METHOD FOR SMOKING OR SMOKE-INFUSING BEVERAGES

(71) Applicants: Bradley Michael Dollins, Hendersonville, NC (US); Gerald Edward Towson, JR., Asheville, NC (US)

(72) Inventors: Bradley Michael Dollins, Hendersonville, NC (US); Gerald Edward Towson, JR., Asheville, NC (US)

(21) Appl. No.: 18/655,892

(22) Filed: May 6, 2024

Related U.S. Application Data
(60) Provisional application No. 63/528,748, filed on Jul. 25, 2023.

(51) Int. Cl. C12G 3/06

(52) U.S. Cl. CPC C12G 3/06

(57) ABSTRACT

The present invention provides a method for smoking or smoke-infusing beverages for human consumption, and the smoked or smoke-infused beverages produced thereby. The method includes the steps of: providing a beverage to be smoked or smoke-infused; providing a smoking or smoke-infusing system, apparatus, or device; operating the smoking or smoke-infusing system, apparatus, or device to provide a quantity of smoke or a smoke-infusion element; conveying the quantity of smoke or the smoke-infusion element to the beverage; and operating the smoking or smoke-infusing system, apparatus, or device to provide a smoked beverage or a smoke-infused beverage. The method may include providing a product container and operating the system, apparatus, or device to smoke the product container before adding the beverage; or to smoke or smoke-infuse the beverage in the product container. The method may also be used to smoke or smoke-infuse foods.

### CROSS-REFERENCE TO RELATED APPLICATIONS

This application claims the benefit of U.S. Provisional Patent Application Ser. No. 63/528,748, filed on Jul. 25, 2023, which is incorporated by reference herein in its entirety.

### FIELD OF THE INVENTION

The present invention relates generally to the field of beverages, and more specifically relates to a novel method for smoking beverages, and smoked beverage compositions.

### BACKGROUND OF THE INVENTION

Many beverages exist for human consumption. For example, plain water and compositions which may be characterized as water beverage products have become an extremely large sector of the beverage industry. Beverage compositions may also include distilled beverages or alcohol drinks, fermented beverages, low-alcohol or non-alcohol beverages, carbonated beverages or soft drinks, fruit juices, fruit drinks, vegetable juices, teas, coffees, milk, milk beverages, hot drinks, and the like.

In the field of distilled spirits, alcohol drinks and compositions, though some distilled spirits are known to be aged in containers which may impart a smoky wood flavor over time, no liquors exist which are formulated to have a smoky flavor without aging the liquor or spirit.

Options which have been developed do not adequately address the problem and do not provide an effective way to add a palatable smoky flavor.

Existing options for smoking an alcoholic beverage may include introducing smoke into a container in which the beverage is stored and letting the beverage rest for 12-24 hours. Such an existing method which his known includes steps of: a) providing at least one fermented distillate with a desired alcohol content; b) placing the at least one distillate in a container, leaving an empty space above the liquid level of the distillate; c) injecting smoke into the empty space in the container to make contact with the at least one distillate; d) resting the container for a desired period of time between 12 and 24 hours; and e) tasting and, by means of the senses, rating the at least one smoked and rested distillate, and, if the sensory rating indicates insufficient smoking, repeating steps 2-4, or, if the sensory rating indicates sufficient smoking, f) proceeding with the final packaging of the at least one distillate.

Other existing methods include immersing an incompletely burned piece of wood in an alcoholic beverage to produce an alcoholic beverage having an aroma, in an apparatus made of a plurality of parts made of a heat-resistant and non-breathable material. The incomplete burning of a piece of wood includes arranging a piece of wood in the container and burning the wood by injecting a replacement gas other than air or oxygen, into the container and then heating the container.

Additional existing options include methods for improving the flavor of alcoholic beverages by setting the syringol content of a beverage at 1 ppb or more.

Further options may include methods or systems for making smoke beverages and foods using multiple condensation stages.

Existing methods fail to provide an effective method for smoking an alcoholic beverage and fail to reliably produce a smoky-flavored or smoke-flavored alcoholic beverage of suitable quality for human consumption.

Ideally, it would be extremely useful to provide a smoked or smoke-infused spirit or alcohol beverage for human consumption.

Accordingly, there is a need for a solution to at least one of the aforementioned problems. For instance, there is an established need for a novel liquor beverage including a smoky flavor, and a method for preparing the beverage without aging the beverage.

### SUMMARY OF THE INVENTION

The present invention is directed to methods for preparing a smoked or smoke-infused beverage or food, and the beverages and foods produced thereby. The present invention is directed to systems, apparatuses, and devices for preparing a smoked or smoke-infused beverage or food. The systems, apparatuses and devices, and methods of the present invention may be used to smoke or smoke-infuse ready to drink (RTD) beverages, spirits, liqueurs, beer, wine, champagne and cocktail mixers, and any other suitable foods or beverages. The present invention is useful for combining the properties associated with smoke flavor and beverages for human consumption. The method may also be beneficially used to make a smoked or smoke-infused food.

The present invention provides unprecedented methods for providing smoke-infused spirits, beverages and cocktails, other beverages, and other foods. The present invention provides beverages and foods having a unique taste with an enhanced smoke flavor. The method of the present invention also provides a way to add smoke to spirits which provides a unique flavor and drinking experience.

In a first implementation, the present invention provides a method for smoking or smoke-infusing a beverage or food for human consumption, the method comprising the steps of:
providing a beverage or food to be smoked or smoke-infused;
providing a smoking or smoke-infusing system, apparatus, or device;
operating the smoking or smoke-infusing system, apparatus, or device to provide a quantity of smoke or a smoke-infusion element;
conveying the quantity of smoke or the smoke-infusion element to the beverage; and
operating the smoking or smoke-infusing system, apparatus, or device to provide a smoked or smoke-infused beverage or food.

Further, in view of the foregoing problems in the known distilled beverage art, and lack of consumer options, the present invention provides a novel method for smoking alcoholic beverages, and beverage compositions smoked thereby. The general purpose of the present invention, which will be described subsequently in greater detail, is to provide an efficient and effective method for smoking alcoholic beverages to impart a tastefully smoked flavor thereto.

Accordingly, the present invention is further directed to methods for preparing a smoked or smoke-infused liquor or alcoholic beverage. The present invention further provides a smoked or smoke-infused beverage produced by a method described herein. In addition, the present invention provides systems, apparatuses, and devices for preparing smoked or smoke-infused beverages.

In one aspect, the present invention is directed to a method for preparing a smoked or smoke-infused beverage (liquor or alcoholic beverage). The method for smoking a liquor or preparing a smoke-infused alcoholic beverage for human consumption comprises one or more of the following steps and combinations thereof:
providing a beverage to be smoked or smoke-infused;
providing a smoking or smoke-infusing system, apparatus, or device;
operating the smoking or smoke-infusing system, apparatus, or device to provide a quantity of smoke or a smoke-infusion element;
conveying the quantity of smoke or the smoke-infusion element to the beverage; and
operating the smoking or smoke-infusing system, apparatus, or device to provide a smoked beverage or a smoke-infused beverage.

In one aspect, the method may further include:
providing a reaction vessel;
adding a predetermined quantity of the beverage to the reaction vessel; and
conveying the quantity of smoke or a smoke-infusion element to the reaction vessel.

In one aspect, the method may further include removing the smoked beverage or the smoke-infused beverage from the vessel; providing a product container or bottle; and placing the smoked beverage or the smoke-infused beverage in the product container or bottle.

In one aspect, the method may include providing a product container or bottle, adding the beverage to be smoked or smoke-infused to the product container or bottle, and operating the smoking or smoke-infusing system, apparatus, or device to provide a smoked beverage or a smoke-infused beverage while the beverage is in the product container or bottle.

In one implementation of the invention, a method for smoking a liquor or preparing a smoke-infused alcoholic beverage for human consumption is provided. The method comprises the steps of:
providing a predetermined quantity of a beverage to be smoked or smoke-infused;
providing a smoking or smoke-infusing system; and
operating the system to smoke or infuse smoke in the predetermined quantity of the beverage.

In one aspect, the system may include at least one smoked container, and at least one smoking apparatus.

In one aspect, the smoking apparatus may comprise:
a smoke machine configured to produce vapor or smoke, the smoke machine further comprising a variable temperature control, a variable-speed air pump and a high-speed exhaust fan;
a high-temperature food-grade hose operably connected to the smoke machine, the air pump and the exhaust fan, the hose configured to transfer vapor or smoke produced by the smoke machine to a desired location, the hose having a first proximal end attached to the smoke machine and a second distal end; and
a set of nozzles comprising a plurality of nozzles configured for removable installation on the second distal end of the hose, each nozzle of the set having a nozzle opening with a nozzle opening diameter, each nozzle having a different nozzle opening diameter.

In one aspect, the at least one smoked container may be any suitable container configured for holding beverages such as ready to drink (RTD) beverages, spirits, liqueurs, beer, wine, champagne and cocktail mixers, and other suitable foods or beverages.

In another aspect, the present invention may provide a method for smoking or smoke-infusing a food or a beverage, the method comprising the steps of:
providing a predetermined quantity of a food or a beverage to be smoked or smoke-infused;
providing a smoking or smoke-infusing system; and
operating the system to smoke or infuse smoke in the predetermined quantity of the food or the beverage.

In one aspect, the method for smoking or smoke-infusing a food or a beverage may comprise:
providing a smoking device or smoke-infusing device;
placing a predetermined quantity of the food or the beverage to be smoked or smoke-infused in a suitable reaction vessel; and
placing the smoking device or the smoke-infusing device in the reaction vessel so the smoking device or the smoke-infusing device may smoke or smoke-infuse the food or the beverage to provide a smoked or smoke-infused food or a smoked or smoke-infused beverage.

In one aspect, the reaction vessel is a food or beverage product container.

In one aspect, the method further comprises removing the smoked or smoke-infused food or the smoked or smoke-infused beverage from the vessel; and providing a product container and placing the smoked or smoke-infused food or smoked or smoke-infused beverage in the product container.

In one aspect, the method comprises the steps of:
providing a beverage comprising a distilled alcohol;
combining a predetermined quantity of the beverage with a predetermined quantity of a smoke component;
infusing the smoke component in the beverage for a predetermined length of time to provide a beverage and smoke component mixture; and
removing the smoke component to provide a smoke or smoke-infused beverage.

In one aspect, the method comprises the steps of:
providing a food;
combining a predetermined quantity of the food with a predetermined quantity of a smoke component;
infusing the smoke component in the food for a predetermined length of time to provide a distilled alcohol and smoke component mixture; and
removing the smoke component to provide the smoke or smoke-infused alcohol.

In one aspect, the present invention provides a method for smoking a liquor or preparing a smoke-infused alcoholic beverage for human consumption. The method comprises the steps of:
providing a predetermined quantity of an alcoholic beverage to be smoked or smoke-infused;
providing a smoking device or smoke-infusing device;
placing the predetermined quantity of a beverage to be smoked in a suitable reaction vessel;
placing the smoking device or the smoke-infusing device in the reaction vessel;
operating the smoking device or the smoke-infusing device to provide a smoked beverage or a smoke-infused alcoholic beverage;
removing the smoked alcoholic beverage or the smoke-infused alcoholic beverage from the vessel; and
providing a product container and placing the smoked alcoholic beverage or the smoke-infused alcoholic beverage in the product container.

In one aspect, operating the smoking device or the smoke-infusing device to provide a smoked alcoholic beverage or a smoke-infused alcoholic beverage comprises infusing the alcoholic beverage with a smoke flavoring component for a predetermined length of time to provide a smoked alcoholic beverage.

In one aspect, the methods for making the smoked or smoke-infused alcoholic beverage may be useful for combining the properties associated with smoke flavor and alcohol for human consumption. The method may also be beneficially used to make a smoked or smoke-infused food.

In one aspect, the method comprises the steps of:
providing a beverage;
combining a predetermined quantity of the beverage with a predetermined quantity of a smoke component;
infusing the smoke component in the distilled alcohol component for a predetermined length of time to provide a distilled alcohol and smoke component mixture; and
removing the smoke component to provide the smoke or smoke-infused alcohol.

In one aspect, the infusing of the smoke component comprises infusing a white smoke substance into an alcoholic spirits container containing a predetermined quantity of an alcoholic beverage.

In one aspect, the infusing of the smoke component comprises infusing a white smoke substance into a container which contains a predetermined quantity of any suitable beverage.

In a further aspect, the infusing of the smoke component comprises infusing a white smoke substance into a container containing a food.

In one aspect, the white smoke substance may comprise smoke generated from the burning of organic material (wood or some other botanical), which may be any plant/vegetative material be it dried, fresh or a blend. The wood or other botanical may be selected from tea leaves, botanicals, plant materials, grains, fruits, vegetables, and combinations thereof.

In one aspect, the white smoke substance may be infused into spirits in large batches.

In one aspect, the white smoke substance may be infused into spirits in an individual container as the container is filled with spirits.

In one aspect, the container may be a bottle, and the white smoke substance may be infused into the spirits individually per-bottle as the bottles are filled with spirits.

In one aspect, the container itself may be smoked separately and then filled with spirits. The container may be a bottle. After the container is smoked, the container may be filled with spirits which area either smoked before being dispensed in the smoked container or are non-smoked.

In one aspect, the present invention provides a process for infusing white smoke into spirit bottles during a spirt bottling process.

In one aspect, the white smoke substance is infused in the bottle on a beverage bottling line.

In one aspect, the step of providing a smoking or smoke-infusing device includes providing a smoking device comprising a source of the white smoke substance, a smoke conveying mechanism, and a length of tubing operatively connected to the smoke conveying mechanism and the source of white smoke. The step of introducing the white smoke substance into the bottle includes conveying the white smoke substance into the beverage bottle through the length of tubing so that the white smoke substance is blown through the tubing and into the beverage.

In one aspect, the smoke conveying mechanism may comprise a smoker machine configured to pump the white smoke substance into the beverage container.

In one aspect, the smoker machine may comprise an air compressor.

In another aspect, the smoker machine may further comprise a housing in which the air compressor is located configured to enhance and concentrate the smoke substance and to isolate the white smoke substance from the area in which the smoking is conducted. The white smoke will be encased on the line to prevent the area from being full of smoke.

In one aspect, the smoker machine may operate to infuse the beverage through pallets.

In one aspect, the smoke conveying mechanism may comprise a hand-operated smoke conveying mechanism.

In one aspect, the smoke may be infused into the spirits by hand, by machine, or by hand and by machine.

In one aspect, the smoke may be initially infused into the spirits by hand, and then infused into the spirits by machine.

In one aspect, the present invention provides an unprecedented method for providing smoke-infused spirits, beverages, and cocktails.

In one aspect, the present invention provides beverages having a unique taste with an enhanced smoke flavor. The method of the present invention provides a way to add smoke to spirits which provides a unique flavor and drinking experience.

In one aspect, the method may comprise conveying the white smoke substance from a smoke machine through a length of tubing and through at least one air stone or infusion stone into one or more of a spirits holding tank, a barrel, and a beverage container or a beverage bottle. The method may be conducted partially by hand, on a bottling assembly line, or both. In some applications with this configuration, a plurality of air stones or infusion stones may be located in a spirits holding tank, so an entire batch of spirits may be smoked all at once.

In another aspect, the method may include the use of dual port injection on the manufacturing line. A first port may be used to pour in the spirits, and a second port may be used to add the smoke to the bottle. The dual port injection via the first port and the second port may occur simultaneously.

In one aspect, the method may include the use of a large vibration tank or barrel mounted on a vibration table, which may be filled with approximately half of its volume comprising spirits, and half of its volume with the smoke substance. In operation, the vibration table will slosh the spirits and the smoke substance, which will cause the causes the smoke substance to become infused in the spirits.

In a further aspect, the present invention provides a system for preparing a smoked or smoke-infused beverage. The system may include at least one smoked container, at least one smoking apparatus. The smoking apparatus may be any suitable smoking apparatus as described hereinabove.

In one aspect, the smoking apparatus may comprise a smoke machine with a variable temperature control to have the variability to process a plant material to produce and deliver vapor, or to produce and deliver smoke. The smoke machine is capable of vaporizing the plant material by heating the plant material just enough to release vapors and is further capable of burning the plant material to create smoke. Vaporizing just heats enough to release vapors and smoking will burn the material to create the smoke.

In one aspect the smoking apparatus includes a smoke machine positioned at a safe distance from the spirits and anything flammable, operably connected to a high-temperature food-grade hose or line to transfer the vapor or smoke to the desired location.

In one aspect, the smoke machine includes a high-speed exhaust fan to move the smoke through the food-grade hose or line. The smoke machine further includes a pump having a variable pump speed. The pressure in the food-grade hose or line may be controlled via choice of tip used at usage site, hose diameter and valves.

In one aspect, the smoke machine may have no heat source if just a natural burn is desired. The smoke machine may also comprise any suitable heat source selected from an infrared heat source, or a heat source such as natural gas, propane, or other common fuel sources and combinations thereof. In some embodiments, the heat source may be a combination of infrared, natural gas, or propane.

In another aspect, the size of the system, apparatus or device may be variable, and may comprise multiple components of various sizes. For example, a portable smoker may be used for manual smoking of beverage bottles, or smoke-infusing at multiple locations such as on-site or off-site uses. The portable smoker may be used to process any plant/vegetative material, be it dried, fresh or a blend.

In a further aspect, the high temperature food-grade hose may be operably connected to a control element configured for use to adjust flow of smoke or vapor such as a button, push valve, floor pedal or be automated.

In another aspect, the smoke machine and/or hose may have various filters at various stages. In some embodiments, a two-stage filter assembly may be provided. The two-stage filter assembly may comprise a first filter configured for location in front of the exhaust fan and a second filter configured to be located beyond the first filter. The filters are constructed and arranged to remove any dust and/or soot particulates. The filters may comprise filter media such as diatomaceous earth or activated charcoal for flavor control.

In another aspect, the system for smoking or smoke-infusing comprises a shaker tank, a blending tank, or a barrel. The system may comprise a tank or barrel supported by an agitation table. The tank or barrel may comprise a one-way valve inlet port where a smoke machine hose may be connected. In use, the tank or barrel may be filled between about 10%-90% of the tank or barrel volume with a liquid beverage of choice, as described herein. Then the smoke will be pumped into fill the headspace to a variable set pressure. The agitation table may be powered on to shake the contents of the tank, thus infusing the liquid with the smoke/vapor. The smoke will likely dissipate into the liquid fully, though a portion of the smoke may remain. The process may be repeated until the desired infusion level is achieved based on a profile of the liquid. The blending tank, shaker/agitation tank or barrel may be manually operated or may be operated by an automatic process. Once the liquid is infused with smoke, the liquid may pass through a series of filters to achieve desired results.

In one aspect, the system for smoking or smoke-infusing a liquid may comprise a blending tank including an air stone of porous material. In use, the blending tank may be filled to desired capacity of liquid, for example between about 5%-95% of the tank volume, followed by smoke/vapor being pumped into the tank by a one-way inlet valve and passed through a porous material such as an air stone. The tank may be filled to a desired pressure, or the smoke/vapor in the area of the tank above the liquid, or headspace, or may be continuously pumped out through an exhaust valve.

In another aspect, the tank may comprise a micropore surface incorporated into a floor of the tank. The micropore surface may comprise one or more porous materials, such as, for example without limitation, air stone, or a micro-perforated metal such as copper or stainless steel. The smoke/vapor may be pumped into the tank through a one-way inlet valve and pass through the porous surface where the smoke/vapor may be held under a desired tank pressure, and/or vented out through one or more exhaust vents, or one or more valves located at the top of the tank. Once infused, the liquid passes through a series of filters to achieve desired flavor profiles. This process can be manual, semi manual, or automated.

In one aspect, the system may comprise a dual port fill mechanism. The dual port fill mechanism may comprise a filling line modified to provide two ports configured to fill simultaneously. The two ports may comprise a first port configured for filling spirits, liquids, or the like, and a second port configured to fill smoke and/or vapor. The dual port fill mechanism may further comprise at least one one-way valve at a top portion configured to release pressure and excess smoke and/or vapor. The dual port fill mechanism may be semi-automatic or automated.

In a further aspect, the system may comprise existing filling lines configured to pre-fill bottles with an inert gas, may be reconfigured to deliver smoke instead of the inert gas for smoking the bottle.

In another aspect, the system may include an ultra-sonic homogenizer or sonicator. The ultra-sonic homogenizer or sonicator may be used in producing smoked or smoke/vapor-infused products or other products. The ultra-sonic homogenizer or sonicator may be used during the blending and mixing of spirits, liqueurs, RTD, cocktail mixers, beer, and other liquid beverages. The ultra-sonic homogenizer or sonicator may be used following smoke/vapor infusion methods where tanks are utilized. The ultra-sonic homogenizer may comprise at least one probe capable of being placed in one or more of a blending tank, a mixing tank, and a barrel, during the mixing and/or blending of an RTD, a spirit, a liqueur, a cocktail mixer, or another liquid beverage. The filling lines may be modified to provide this process post dual port injection. Once a container is filled with a liquid beverage, the container would be advanced to the ultra-sonic homogenizer and a probe would be lowered into the containers and pulsed for the desired amount of time to achieve the desired level of homogenization.

In one aspect, the method may include providing a liquid beverage which is passed through an ultra-sonic homogenizer machine that allows liquids to flow therethough. The ultra-sonic homogenizer machine may include a probe over which the liquids pass before returning to a blending, mixing, or holding tank or barrel. Using an ultra-sonic homogenizer breaks apart long chain molecules which may cause undesired traits in liquids such as burn in spirits and may be beneficially employed to create a smoother spirit. The use of an ultra-sonic homogenizer may occur before or after additionally filtering post-infusion. The use of an ultra-sonic homogenizer essentially makes the liquids nano emulsions.

In one aspect, the method may include providing a beverage container which may be manually treated with smoke and/or vapor, in a process using a permanently installed or portable smoke machine to fill containers with smoke and/or vapor. The containers may be at any safe location, such as on a pallet, in cases, or on a fill station or fill line. The containers may be filled immediately after being treated with smoke and/or vapor. In some embodiments, the containers may alternatively be corked or capped until the smoke has dissipated, and then filled. The hose from the smoke machine would have a nozzle tip installed thereon which would permit the tip to be inserted into the container and then filled to desired level.

In one aspect, treatment of the container with smoke and/or vapor may be semi-automatic or automatic. For example, semi-automatic or automatic filling lines may be modified to include a section for treatment with smoke and/or vapor. The container may pass beneath a smoke/vapor injection port. The smoke/vapor injection port may be positioned just above the containers at a level set manually or automatically depending on the filling line. The smoke/vapor injection port may also be configured to be lowered into the container. The smoke/vapor will fill the container to a desired level. The smoke/vapor injection port may have a one-way valve to permit excess smoke/vapor to vent out. After treatment of the container with smoke and/or vapor, the containers may be capped and rested until the smoke/vapor fully dissipates or may be advanced down the line to be filled with smoke/vapor still in the container. These smoked/vapored containers could be used for any food or beverage products including RTD products, spirits, liqueurs, beer, cocktail mixers, oils, liquids, or the like.

In one aspect, the method of the present invention may also include shaking or blending to infuse smoke into RTD products, spirits, liqueurs, beer, cocktail mixers, oils, or other liquids. The shaking or blending may be effected using one or more of a shaker tank, a barrel, a blending tank with an air stone, a blending tank with a built-in porous surface, and a dual port fill to infuse smoke and/or vapor into RTD products, liquors, liqueurs, beverages, beer, cocktail mixers, oils and liquids, or combinations thereof.

In one aspect, the method may include providing various smoked materials such as smoked teas and other botanicals may be steeped in any suitable liquid such as RTD products, liquors, liqueurs, beer, cocktail mixers, oils, and liquids. Prior to steeping in the liquid, the tea leaves, botanicals, plant materials, grains, fruits, vegetables, or the like, may be smoked in a smoker using various types of wood or other organic materials such as botanicals, etc. to infuse them with the smoke scent and taste. This process can be repeated several times until the desired effect is achieved. The intended material may be soaked in water before and in between smoking sessions depending on desired results, materials, temperature, and humidity levels. The material may be stored in new or used wood barrels with water, spirits, or other beverage liquids and aged until the desired result is achieved. The material may be smoked again once removed from the barrels to dry and enhance the smoke aroma and flavor. The smoked material would then be placed into a steeping bag which may be placed into a barrel or a blending tank with the liquid to be smoked or smoke-infused. The time, temperature, and possible agitation or no agitation associated with the steeping will potentially affect the result and offers a range of depth for choice. Once the time of steeping is up, the infusion is complete. The product is ready to be bottled as is or may go through one or more additional smoking or smoke-infusion methods as described herein to provide an even deeper smoke flavor and scent.

In another aspect, the smoking and smoke-infusion methods described herein may be fully automated in the same way that processing the liquids is automated. The systems may be configured to control the smoke/vapor aspects in the same way it controls the liquids. Time of fill, pressure, and other parameters may be aspects of data for control of the automated system, depending on which system is used.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a flow chart of a method in accordance with a first illustrative embodiment of the present invention;

FIG. 2 presents a flow chart of a method in accordance with an illustrative embodiment of the present invention;

FIG. 3 presents a flow chart of a method in accordance with an illustrative embodiment;

FIG. 4 presents a flow chart of a method in accordance with an illustrative embodiment;

FIG. 5 presents a flow chart of a method in accordance with an illustrative embodiment;

FIG. 6 presents a flow chart of a method in accordance with an illustrative embodiment;

FIG. 7 presents a flow chart of a method in accordance with an illustrative embodiment;

FIG. 8 presents a flow chart of a method in accordance with an illustrative embodiment;

FIG. 9 presents a flow chart of a method in accordance with an illustrative embodiment;

FIG. 10 presents a flow chart of a method in accordance with an illustrative embodiment;

FIG. 11 presents a flow chart of a method in accordance with an illustrative embodiment;

FIG. 12 presents a flow chart of a method in accordance with an illustrative embodiment;

FIG. 13 presents a flow chart of a method in accordance with an illustrative embodiment;

FIG. 14 presents a flow chart of a method in accordance with an illustrative embodiment;

FIG. 15 presents a flow chart of a method in accordance with an illustrative embodiment;

FIG. 16 presents a schematic view of a smoking assembly of a system in accordance with an illustrative embodiment of the present invention;

FIG. 17 presents a schematic view of a smoking assembly of a system in accordance with an illustrative embodiment of the present invention;

FIG. 18 presents a schematic view of a smoker that may be included in the smoking assembly as in FIG. 16;

FIGS. 19A-B present schematic views of smokers that may be included in the smoking assembly as in FIG. 16;

FIG. 20 presents a schematic view of a smoker that may be included in the smoking assembly as in FIG. 16;

FIG. 21 presents a schematic view of a smoker that may be included in the smoking assembly as in FIG. 16;

FIG. 22 presents a schematic view of a mixing tank with an air stone which may be included in a system in accordance with the present invention;

FIG. 23 presents a schematic view of a mixing tank with an air stone which may be included in a system in accordance with the present invention;

FIG. 24 presents a schematic view of a mixing tank and a vibration table which may be included in a system in accordance with the present invention;

FIG. 25 presents a schematic view of a mixing tank and a vibration table which may be included in a system in accordance with the present invention;

FIG. 26 presents a schematic view of a barrel and a vibration table which may be included in a system in accordance with the present invention;

FIG. 27 presents a schematic view of a vibration table which may be included in a system in accordance with the present invention;

FIG. 28 presents a schematic view of a bottling line which may be included in a system in accordance with the present invention;

FIGS. 29A-E present schematic views of a homogenizer which may be included in a system in accordance with the present invention;

FIG. 30 presents a schematic view of a homogenizer which may be included in a system in accordance with the present invention;

FIGS. 31A-C present schematic views of distillation apparatuses which may be included in a system in accordance with the present invention;

FIGS. 32A-B present schematic views of a lenticular filter which may be included in a system in accordance with the present invention;

FIGS. 33A-B present schematic views of a press-type filter which may be included in a system in accordance with the present invention;

FIG. 34 presents a schematic view of a smoking system in accordance with an illustrative embodiment of the present invention; and

FIG. 35 presents a schematic view of a smoke-infusing system in accordance with an illustrative embodiment of the present invention.

Like reference numerals refer to like parts throughout the several views of the drawings.

### DETAILED DESCRIPTION

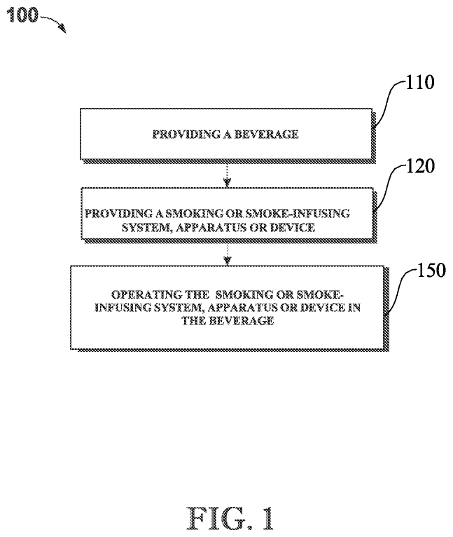

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed to systems, apparatuses, and devices for preparing a smoked or smoke-infused beverage or food. The present invention is further directed to methods for preparing a smoked or smoke-infused beverage or food, and the beverages and foods produced thereby.

The systems, apparatuses and devices, and methods of the present invention may be used to smoke or smoke-infuse ready to drink (RTD) beverages, spirits, liqueurs, beer, wine, champagne and cocktail mixers, and any other suitable foods or beverages. The present invention is useful for combining the properties associated with smoke flavor and beverages for human consumption. The method may also be beneficially used to make a smoked or smoke-infused food.

The present invention provides unprecedented methods for providing smoke-infused spirits, beverages and cocktails, other beverages, and other foods. The present invention provides beverages and foods having a unique taste with an enhanced smoke flavor. The method of the present invention also provides a way to add smoke to spirits which provides a unique flavor and drinking experience.

As shown at FIG. 1, a method for smoking a beverage or preparing a smoke-infused beverage for human consumption may comprise the steps of:
110 providing a beverage to be smoked or smoke-infused;
120 providing a smoking or smoke-infusing system, apparatus, or device; and
150 operating the system to smoke or infuse smoke in the predetermined quantity of the beverage.

The beverage may be any suitable beverage, such as, for example without limitation, an alcoholic beverage.

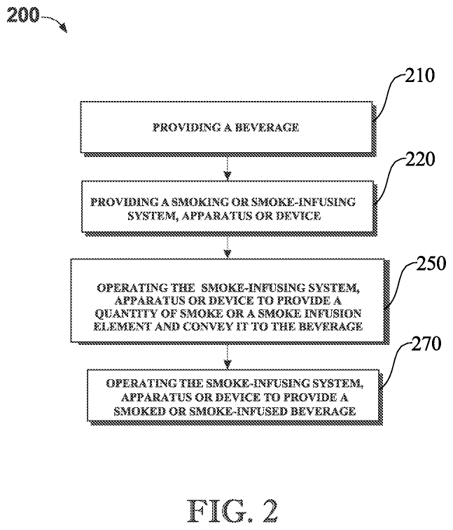

As shown at FIG. 2, a method 200 for smoking a beverage or preparing a smoke-infused beverage for human consumption comprises one or more of the following steps and combinations thereof:
210 providing a beverage to be smoked or smoke-infused;
220 providing a smoking or smoke-infusing system, apparatus, or device;
250 operating the smoking or smoke-infusing system, apparatus, or device to provide a quantity of smoke or a smoke-infusion element, and conveying the quantity of smoke or the smoke-infusion element to the beverage; and
270 operating the smoking or smoke-infusing system, apparatus, or device to provide a smoked beverage or a smoke-infused beverage.

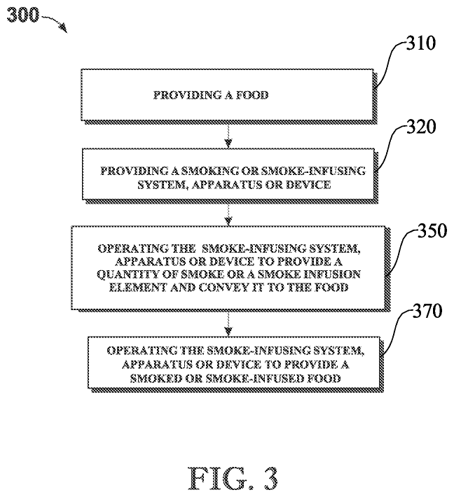

Referring to FIG. 3, a flow chart of a method for preparing a smoked or smoke-infused food is shown. A method for smoking a food or preparing a smoke-infused food for human consumption comprises one or more of the following steps and combinations thereof:
310 providing a food to be smoked or smoke-infused;
320 providing a smoking or smoke-infusing system, apparatus, or device;
350 operating the smoking or smoke-infusing system, apparatus, or device to provide a quantity of smoke or a smoke-infusion element, and conveying the quantity of smoke or the smoke-infusion element to the food; and
370 operating the smoking or smoke-infusing system, apparatus, or device to provide a smoked food or a smoke-infused food.

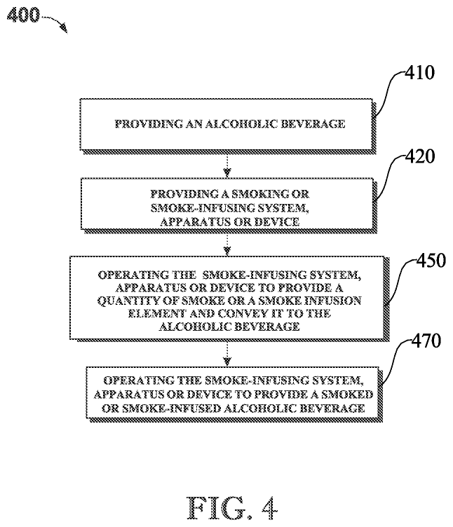

Referring to FIG. 4, a flow chart of a method for preparing a smoked or smoke-infused alcoholic beverage is shown. A method 400 for smoking a liquor or preparing a smoke-infused alcoholic beverage for human consumption comprises one or more of the following steps and combinations thereof:
410 providing an alcoholic beverage to be smoked or smoke-infused;
420 providing a smoking or smoke-infusing system, apparatus, or device;
450 operating the smoking or smoke-infusing system, apparatus, or device to provide a quantity of smoke or a smoke-infusion element and conveying the quantity of smoke or the smoke-infusion element to the beverage; and
470 operating the smoking or smoke-infusing system, apparatus, or device to provide a smoked beverage or a smoke-infused beverage.

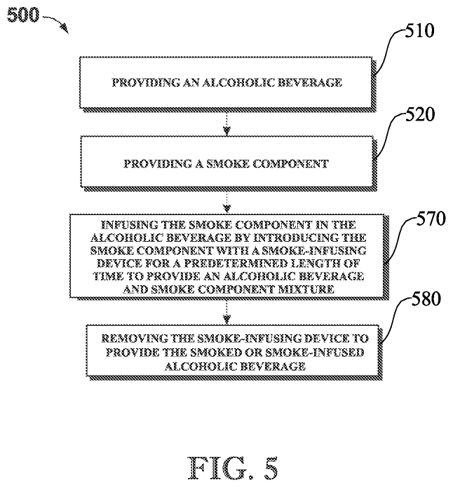

Referring to FIG. 5, method (500) for smoke-infusing an alcoholic beverage is illustrated in accordance with an exemplary embodiment of the present invention. An alcoholic beverage is provided (510). A smoke component is provided (520). The smoke component is infused in the alcoholic beverage by introducing the smoke component with a smoke-infusing device for a predetermined length of time to provide an alcoholic beverage and smoke component mixture (550). The smoke-infusing device is removed, to provide the smoked or smoke-infused alcoholic beverage (570).

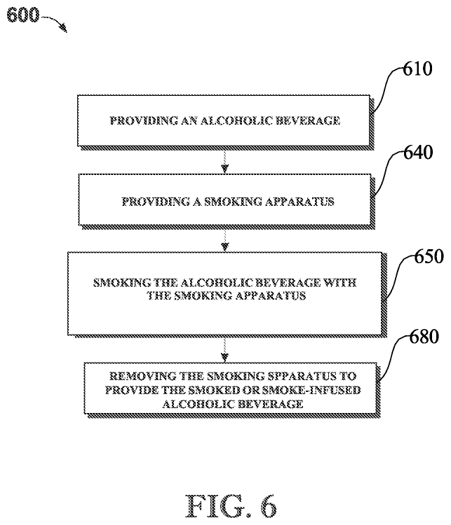

As shown at FIG. 6, a method (600) for smoking a liquor for human consumption may comprise the steps of:
(610) providing a predetermined quantity of a beverage to be smoked;
(640) providing the smoking apparatus;
(650) smoking the beverage with the smoking apparatus; and
(680) removing the smoking apparatus from the beverage, to provide the smoked or smoke-infused alcoholic beverage.

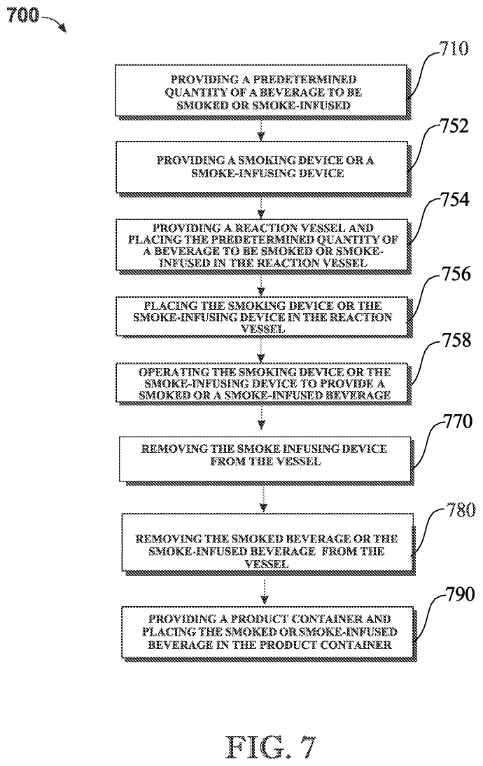

As shown at FIG. 7, a method (700) may comprise the following steps:
(710) providing a predetermined quantity of a beverage to be smoked or smoke-infused;
(752) providing a smoking device or a smoke-infusing device;
(754) providing a reaction vessel and placing the predetermined quantity of a beverage to be smoked or smoke-infused in the reaction vessel;
(756) placing the smoking device or the smoke-infusing device in the reaction vessel;
(758) operating the smoking device or the smoke-infusing device to provide a smoked or a smoke-infused beverage;
(770) removing the smoke-infusing device from the vessel;
(780) removing the smoked beverage or the smoke-infused beverage from the vessel; and
(790) providing a product container and placing the smoked or smoke-infused beverage in the product container.

The reaction vessel may be any suitable vessel, including but not limited to, a tank, a vat, a barrel, any laboratory glassware, or the like.

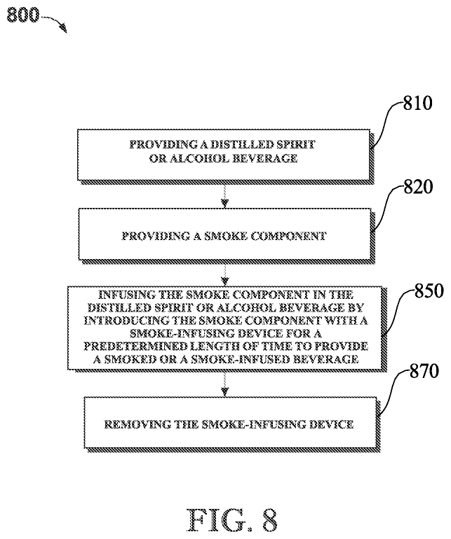

FIG. 8 shows a method (800) comprising providing a distilled spirit or alcohol beverage (810), providing a smoke component (820), infusing the smoke component in the distilled spirit or alcohol beverage by introducing the smoke component with a smoke-infusing device for a predetermined length of time to provide a smoked or a smoke-infused beverage (850) and removing the smoke-infusing device (870).

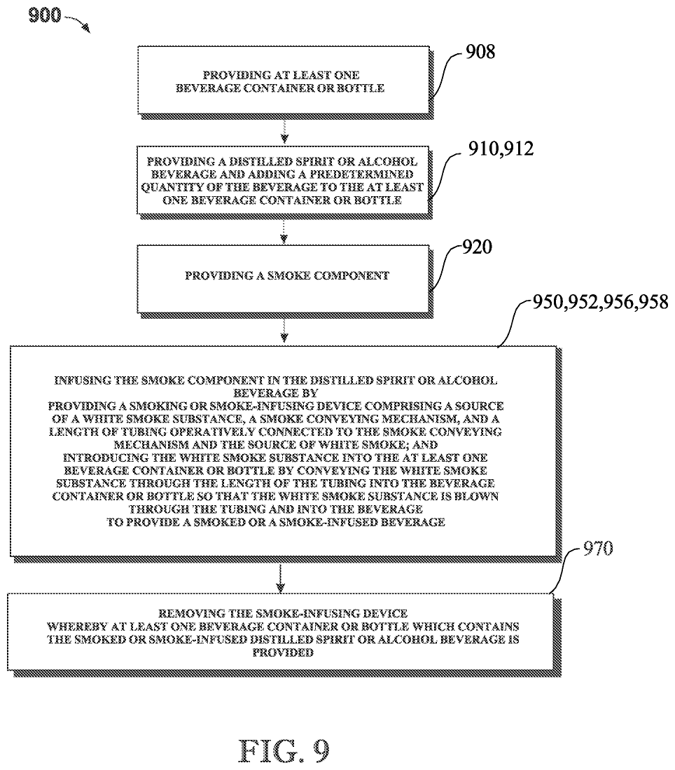

FIG. 9 shows a method (900) comprising:
providing at least one beverage container or bottle (908);
providing a distilled spirit or alcohol beverage and adding a predetermined quantity of the beverage to the at least one beverage container or bottle (910,912);
providing a smoke component (920);
infusing the smoke component in the distilled spirit or alcohol beverage by providing a smoking or smoke-infusing device comprising a source of a white smoke substance, a smoke conveying mechanism, and a length of tubing operatively connected to the smoke conveying mechanism and the source of white smoke; and introducing the white smoke substance into the at least one beverage container or bottle by conveying the white smoke substance through the length of the tubing into the beverage container or bottle so that the white smoke substance is blown through the tubing and into the beverage to provide a smoked or a smoke-infused beverage (950,952,956,958); and
removing the smoke-infusing device (970) whereby at least one beverage container or bottle which contains the smoked or smoke-infused distilled spirit or alcohol beverage is provided.

The beverage container may be any container suitable for beverages, such as, for example without limitation, a tank, a vat, a barrel, beverage, or laboratory glassware, or the like.

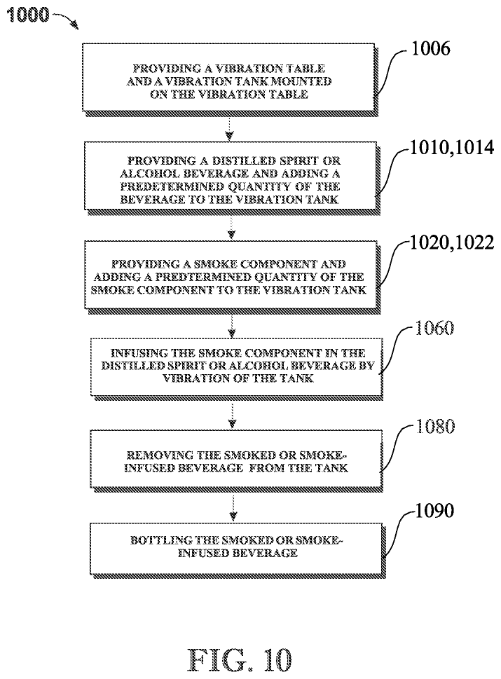

Referring to FIG. 10, a method (1000) may comprise:
providing a vibration table and a vibration tank or a barrel mounted on the vibration table (1006);
providing a distilled spirit or alcohol beverage and adding a predetermined quantity of the beverage to the vibration tank (1010,1014);
providing a smoke component and adding a predetermined quantity of the smoke component to the vibration tank (1020,1022);
infusing the smoke component in the distilled spirit or alcohol beverage by vibration of the tank (1060);
removing the smoked or smoke-infused beverage from the tank (1080); and
bottling the smoked or smoke-infused beverage (1090).

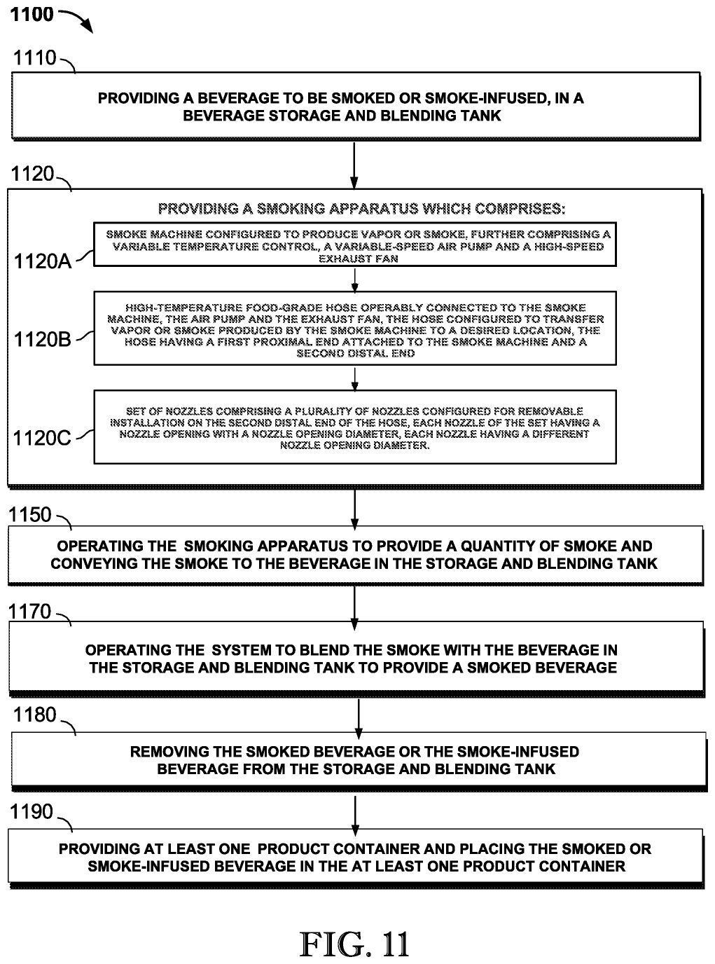

Referring to FIG. 11, a method (1100) may comprise:
(1110) providing a beverage to be smoked or smoke-infused, in a beverage storage and blending tank or a barrel;
(1120) providing a smoking apparatus which comprises:
(1120A) a smoke machine configured to produce vapor or smoke, further comprising: a variable temperature control; a variable-speed air pump; and a high-speed exhaust fan;
(1120B) a high-temperature food-grade hose operably connected to the smoke machine the air pump and the exhaust fan, the hose configured to transfer vapor or smoke produced by the smoke machine to a desired location, the hose having a first proximal end attached to the smoke machine and a second distal end; and
(1120C) a set of nozzles comprising a plurality of nozzles configured for removable installation on the second distal end of the hose, each nozzle of the set having a nozzle opening with a nozzle opening diameter, each nozzle having a different nozzle opening diameter.
(1150) operating the smoking apparatus to provide a quantity of smoke and conveying the smoke to the beverage in the storage and blending tank or the barrel;
(1170) operating the system to blend the smoke with the beverage in the storage and blending tank or the barrel to provide a smoked beverage;
(1180) operating the system to blend the smoke with the beverage in the storage and blending tank or the barrel to provide a smoked beverage; and
(1190) providing at least one product container and placing the smoked or smoke-infused beverage in the at least one product container.

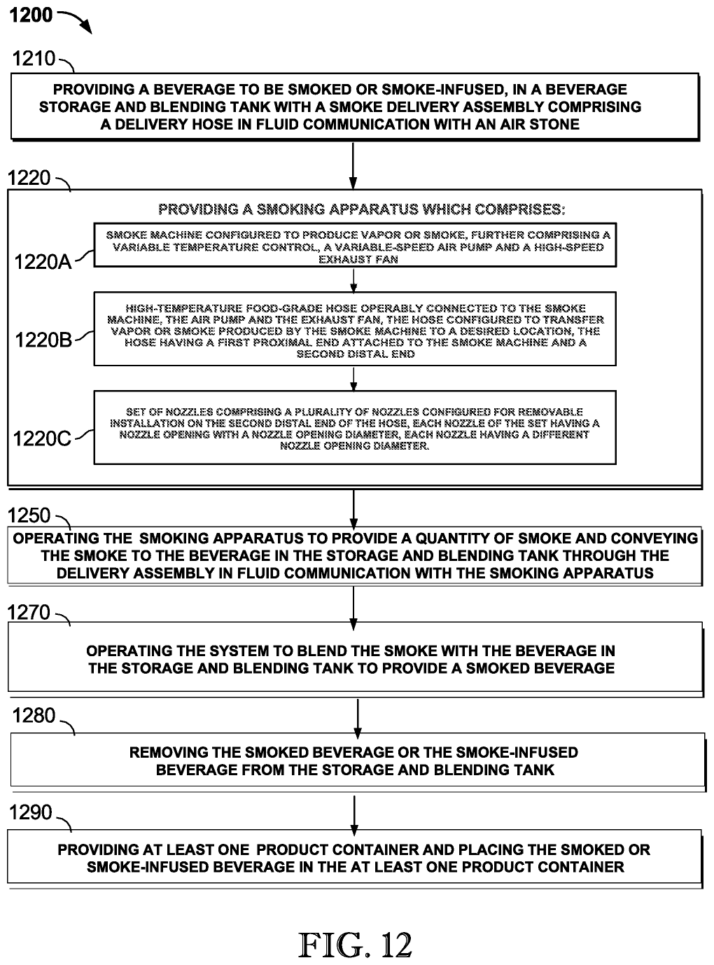

Referring to FIG. 12, a method (1200) may comprise:
(1210) providing a beverage to be smoked or smoke-infused, in a beverage storage and blending tank or a barrel, with a smoke delivery assembly comprising a delivery hose in fluid communication with an air stone;
(1220) providing a smoking apparatus which comprises: (1220A) a smoke machine configured to produce vapor or smoke, further comprising a variable temperature control, a variable-speed air pump and a high-speed exhaust fan; (1220B) a high-temperature food-grade hose operably connected to the smoke machine, the air pump and the exhaust fan, the hose configured to transfer vapor or smoke produced by the smoke machine to a desired location, the hose having a first proximal end attached to the smoke machine and a second distal end; and (1220C) a set of nozzles comprising a plurality of nozzles configured for removable installation on the second distal end of the hose, each nozzle of the set having a nozzle opening with a nozzle opening diameter, each nozzle having a different nozzle opening diameter;
(1250) operating the smoking apparatus to provide a quantity of smoke and conveying the smoke to the beverage in the storage and blending tank or the barrel through the delivery assembly in fluid communication with the smoking apparatus;
(1270) operating the system to blend the smoke with the beverage in the storage and blending tank or the barrel to provide a smoked beverage;
(1280) removing the smoked beverage or the smoke-infused beverage from the storage and blending tank or the barrel; and
(1290) providing at least one product container and placing the smoked or smoke-infused beverage in the at least one product container.

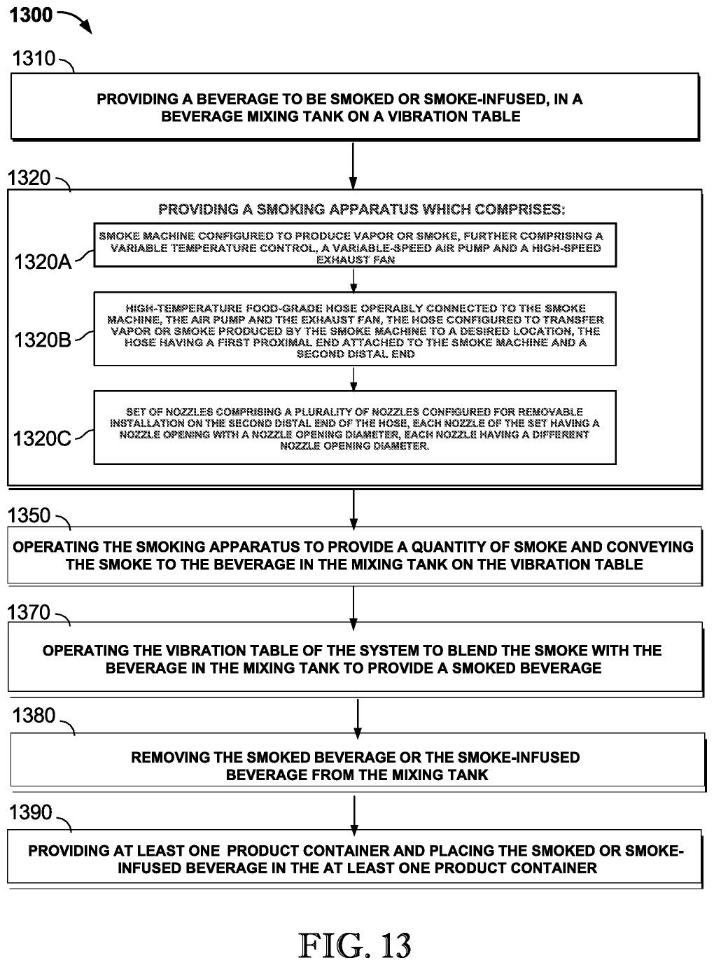

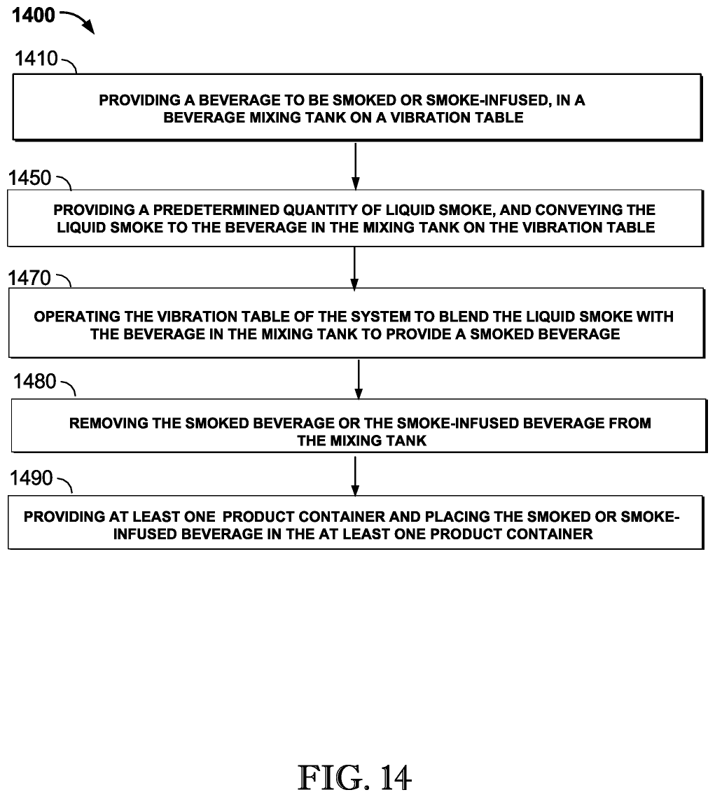

Referring to FIG. 13, a method (1300) may comprise:
(1310) providing a beverage to be smoked or smoke-infused, in a beverage mixing tank or a barrel, on a vibration table;
(1320) providing a smoking apparatus which comprises: (1320A) a smoke machine configured to produce vapor or smoke, further comprising a variable temperature control, a variable-speed air pump and a high-speed exhaust fan; (1320B) a high-temperature food-grade hose operably connected to the smoke machine, the air pump and the exhaust fan, the hose configured to transfer vapor or smoke produced by the smoke machine to a desired location, the hose having a first proximal end attached to the smoke machine and a second distal end; and (1320C) a set of nozzles comprising a plurality of nozzles configured for removable installation on the second distal end of the hose, each nozzle of the set having a nozzle opening with a nozzle opening diameter, each nozzle having a different nozzle opening diameter;
(1350) operating the smoking apparatus to provide a quantity of smoke and conveying the smoke to the beverage in the mixing tank or the barrel on the vibration table;
(1370) operating the vibration table of the system to blend the smoke with the beverage in the mixing tank or the barrel to provide a smoked beverage;
(1380) removing the smoked beverage or the smoke-infused beverage from the mixing tank or the barrel; and
(1390) providing at least one product container and placing the smoked or smoke-infused beverage in the at least one product container.
Referring now to FIG. 14, a method (1400) may comprise:
(1410) providing a beverage to be smoked or smoke-infused, in a beverage mixing tank or a barrel, on a vibration table;
(1450) providing a predetermined quantity of liquid smoke, and conveying the liquid smoke to the beverage in the mixing tank or the barrel on the vibration table;
(1470) operating the vibration table of the system to blend the liquid smoke with the beverage in the mixing tank or the barrel to provide a smoked beverage;
(1480) removing the smoked beverage or the smoke-infused beverage from the mixing tank or the barrel; and
(1490) providing at least one product container and placing the smoked or smoke-infused beverage in the at least one product container.

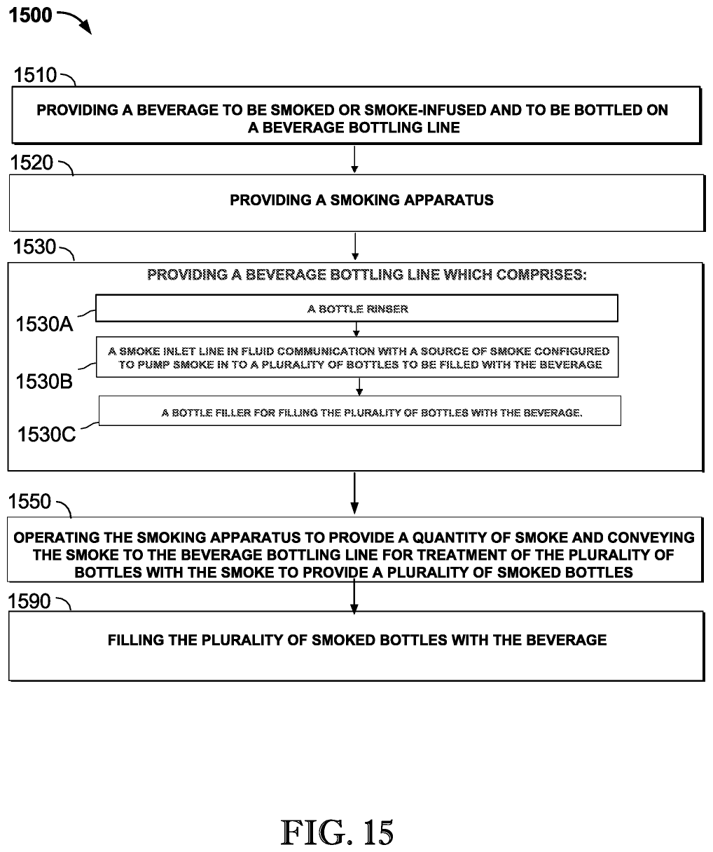

Referring now to FIG. 15, a method (1500) may comprise:
(1510) providing a beverage to be smoked or smoke-infused and to be bottled on a beverage bottling line;
(1520) providing a smoking apparatus;
(1530) providing a beverage bottling line which comprises: (1530A) a bottle rinser; (1530B) a smoke inlet line in fluid communication with a source of smoke configured to pump smoke into a plurality of bottles to be filled with the beverage; and (1530C) a bottle filler for filling the plurality of bottles with the beverage;
(1550) operating the smoking apparatus to provide a quantity of smoke and conveying the smoke to the beverage bottling line for treatment of the plurality of bottles with the smoke to provide a plurality of smoked bottles; and
(1590) filling the plurality of smoked bottles with the beverage.

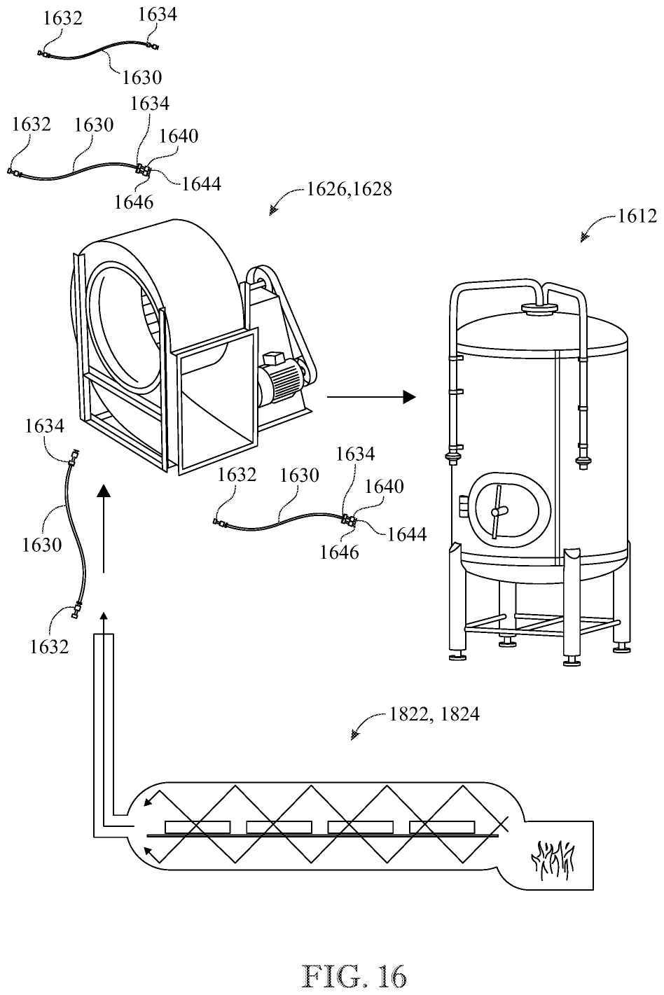

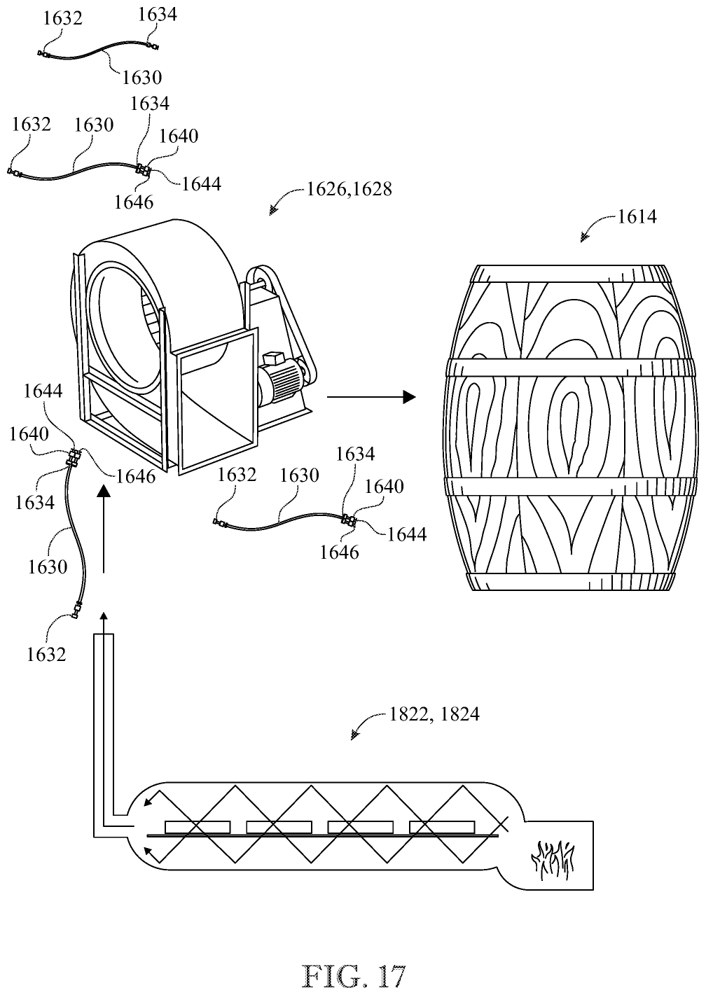

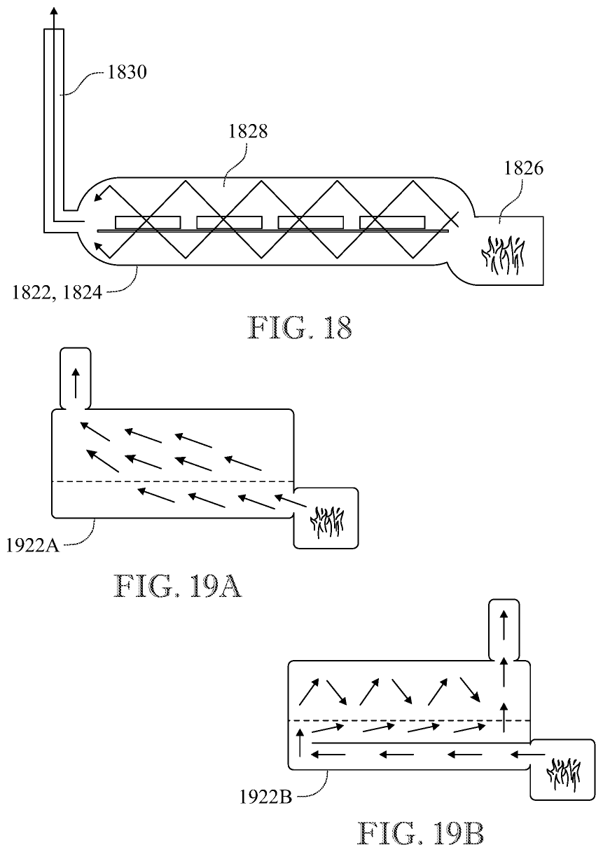

Referring to FIG. 16-18, a schematic view of a smoking device, system or apparatus of the present invention is shown. Referring to FIG. 16-17, the apparatus 1600 may comprise a smoke machine assembly 1822 which comprises a smoke machine 1822 (also shown and described with reference to FIG. 18) configured to produce vapor or smoke. As shown at FIG. 18, the smoke machine 1822 may further comprise a variable temperature control 1824. The smoke machine assembly 1822 further comprises a variable-speed air pump 1826, a high-speed exhaust fan 1828, and an exhaust conduit 1830.

The inline blower for the smoke may comprise any suitable fan. In some embodiments, the fan may be a belt-driven centrifugal fan as shown. This is used essentially as an exhaust fan for the smoke wherein the exit line is piped into the system for blowing smoke into tanks, barrels, bottles, and other areas of the system as needed.

The apparatus may include at least one high-temperature food-grade hose 1630 operably connected to the smoke machine assembly 1822, the air pump 1626, and the exhaust fan 1628. The at least one high-temperature food-grade hose 1630 is configured to transfer vapor or smoke produced by the smoke machine assembly to a blending and storage container 1612 as shown at FIG. 16 or a barrel 1614 as shown at FIG. 17. The hose 1630 comprises a first proximal end 1632 and a second distal end 1634. A hose 1630 is configured to be attached to the smoke machine assembly 1822 to transfer vapor or smoke produced by the smoke machine assembly 1822 to a desired location. The hose first proximal end 1632 may be attached to the smoke machine assembly 1822. A set of nozzles 1640 comprising a plurality of nozzles is configured for removable installation on the hose second distal end 1634, each nozzle of the set having a nozzle opening 1644 with a nozzle opening diameter 1646, each nozzle having a different nozzle opening diameter. In some embodiments, a single nozzle may be provided at the hose second distal end 1634. As shown at FIG. 16, the blending and storage container 1612 is in fluid communication with the high-temperature food-grade hose 1630 and the set of nozzles 1640, the blending and storage container 1612 being configured to receive vapor or smoke produced by the smoke machine assembly 1822, and a food or a beverage to be blended with the vapor or smoke to produce a smoked or smoke-infused food or beverage. As shown at FIG. 17, the barrel 1614 is in fluid communication with the high-temperature food-grade hose 1630 and the set of nozzles 1640, the barrel 1614 being configured to receive vapor or smoke produced by the smoke machine assembly 1822, and a food or a beverage to be blended with the vapor or smoke to produce a smoked or smoke-infused food or beverage.

A nonlimiting example of a storage and blending tank is commercially available from ABT (Allied Blending Tanks, Inc.). A nonlimiting example of a barrel is commercially available from barrelsonline.com.

The smoke machine and/or hose may have various filters at various stages. In some embodiments, a two-stage filter assembly may be provided. The two-stage filter assembly may comprise a first filter configured for location in front of the exhaust fan and a second filter configured to be located beyond the first filter. The filters are constructed and arranged to remove any dust and/or soot particulates. The filters may comprise filter media such as diatomaceous earth or activated charcoal for flavor control.

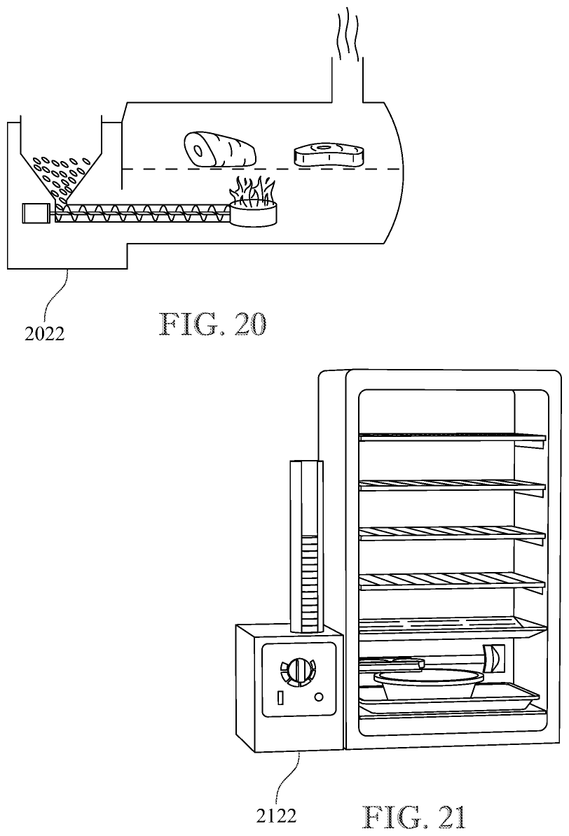

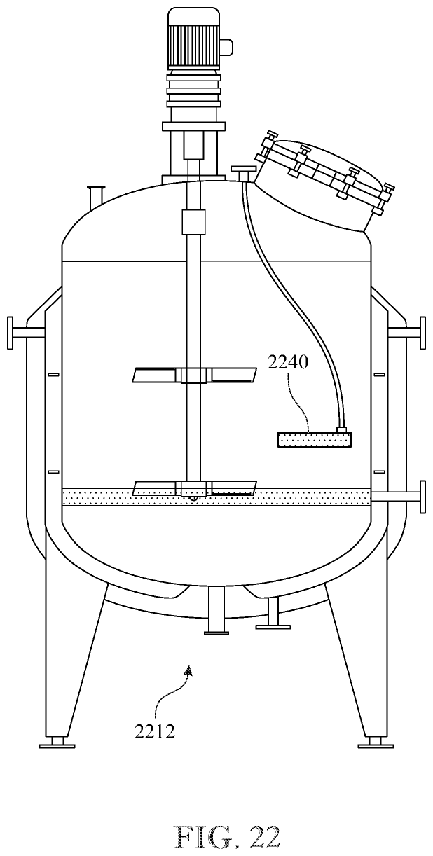

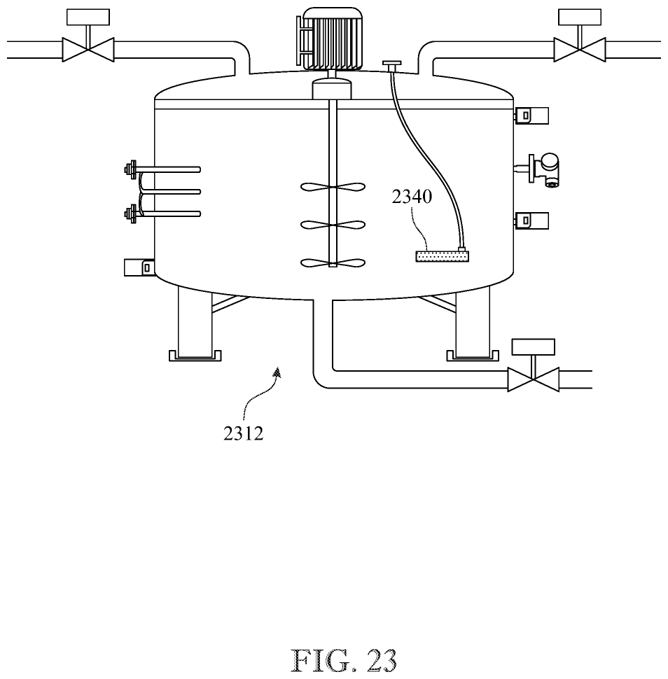

The smoker may be any suitable smoker. Referring to FIG. 18, FIGS. 19A-B, and FIGS. 20-21, nonlimiting examples of smokers which may be used are shown. FIG. 18 shows a conventional smoker or smoking assembly 1822 with a firebox 1826 for burning wood or other chosen material to be smoked, a cook chamber 1828, and a smokestack 1830 which would be operably connected to the other components of the system.

The smoker may be a regular offset smoker, or a reverse flow offset smoker. FIG. 19A shows a regular offset smoker 1922A, and FIG. 19B shows a reverse flow offset smoker 1922B. FIG. 20 shows a smoker 2022 which uses a pellet hopper. The smokers shown may generate smoke from the burning of organic material (wood or some other botanical), which may be any plant/vegetative material be it dried, fresh or a blend. The wood or other botanical may be selected from tea leaves, botanicals, plant materials, grains, fruits, vegetables, and combinations thereof.

FIG. 21 shows a smoker 2122 which uses a wood hopper. This type of smoker will be used for smoking materials to be used for steeping, or in a gin basket during distillation. The materials such as tea, wood chips, botanicals, or the like, may be placed on the smoking racks and smoked for various times, temperatures and types of material used to smoke depending on the desired outcome. If the material is intended to be a dried product and is not dry enough coming out of the smoker, it will be dried using a method of industrial food drying such as a dehydrator or drying line, or the like.

Wood may be placed in the firebox of the smoker. The cook chamber may be empty. In some embodiments, the chamber may be filled with botanicals in accordance with the methods described herein. In some embodiments, the smoker may include a pellet hopper configured to receive wood pellets to be conveyed to a firepot. A material to be smoked (tea, wood, botanical) may be placed in the smoking chamber.

Nonlimiting examples of commercially available smokers include CTO Residential Smoker, EL-EDX Commercial Smoker, CTO-DW Commercial Smoker, commercially available from olehickorychips.com.

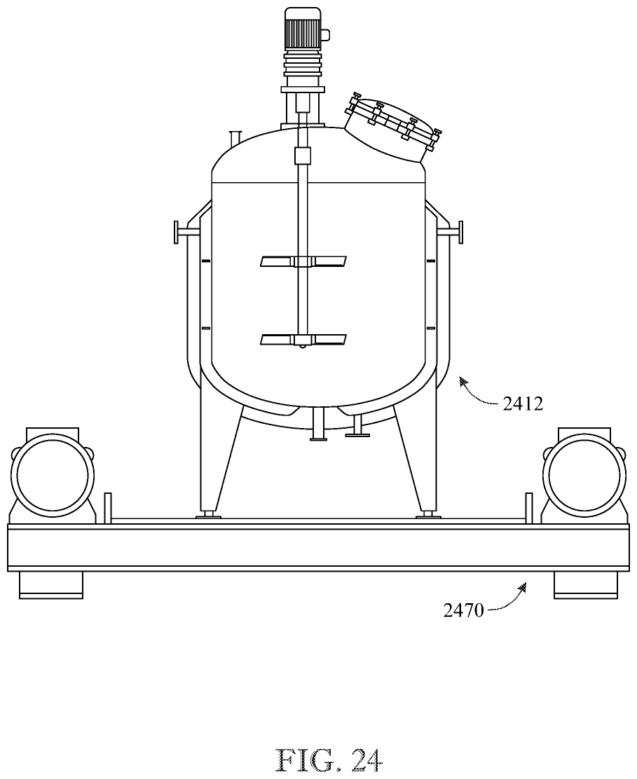

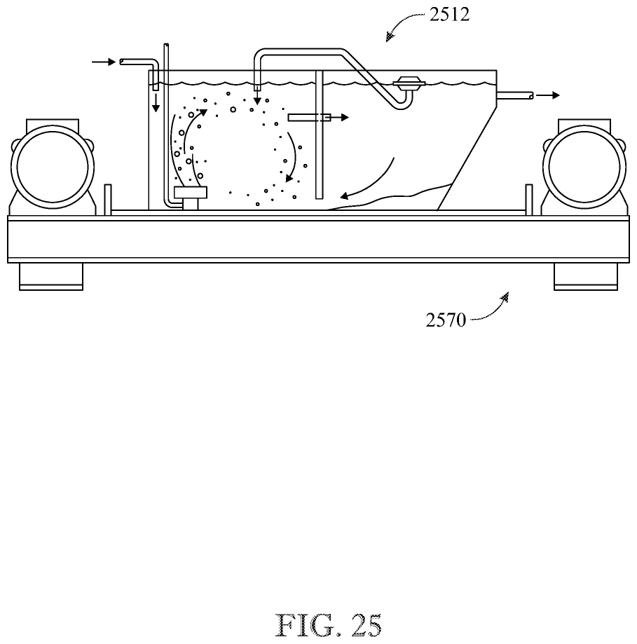

Referring to FIGS. 22-23, mixing tanks are shown which may be used with an air stone. FIG. 22 and FIG. 23 show mixing tanks 2212,2312 which may be used in with an aeration stone 2240,2340. The aeration stone 2240,2340 may be a pumice block that is connected to a smoke inlet line and placed into the tank. The air stone may be any suitable stone of porous material.

Further, the type of mixing tank 2212 shown in FIG. 22 may be used with an air stone 2240 in a method as described with reference to FIG. 12. FIG. 23 also shows a mixing tank 2312 which may be used with an air stone 2340 in a method as described with reference to FIG. 12.

In use, the blending tank may be filled to desired capacity of liquid, for example between about 5%-95% of the tank volume, followed by smoke/vapor being pumped into the tank by a one-way inlet valve and passed through a porous material such as an air stone. The tank may be filled to a desired pressure, or the smoke/vapor in the area of the tank above the liquid, or headspace, or may be continuously pumped out through an exhaust valve.

In some embodiments, the tank may comprise a micropore surface incorporated into a floor of the tank. The micropore surface may comprise one or more porous materials, such as, for example without limitation, air stone or a micro-perforated metal such as copper or stainless steel. The smoke/vapor may be pumped into the tank through a one-way inlet valve and pass through the porous surface where the smoke/vapor may be held under a desired tank pressure, and/or vented out through one or more exhaust vents, or one or more valves located at the top of the tank. Once infused, the liquid passes through a series of filters to achieve desired flavor profiles. This process can be manual, semi manual, or automated.

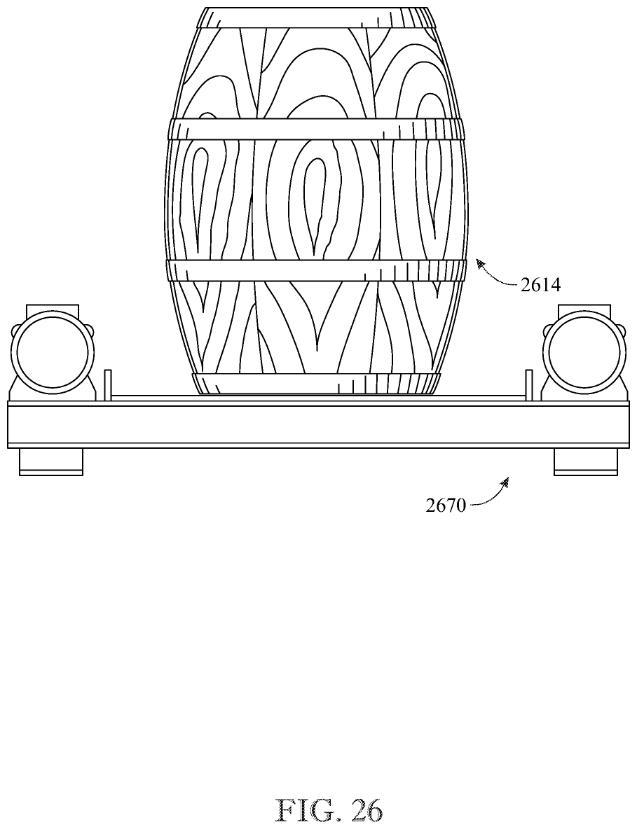

Further, the type of mixing tank 2212 shown at FIG. 22 may be used with a vibration table as described herein with reference to FIG. 10, and FIGS. 13-14, and as described hereinbelow with reference to FIGS. 24-26.

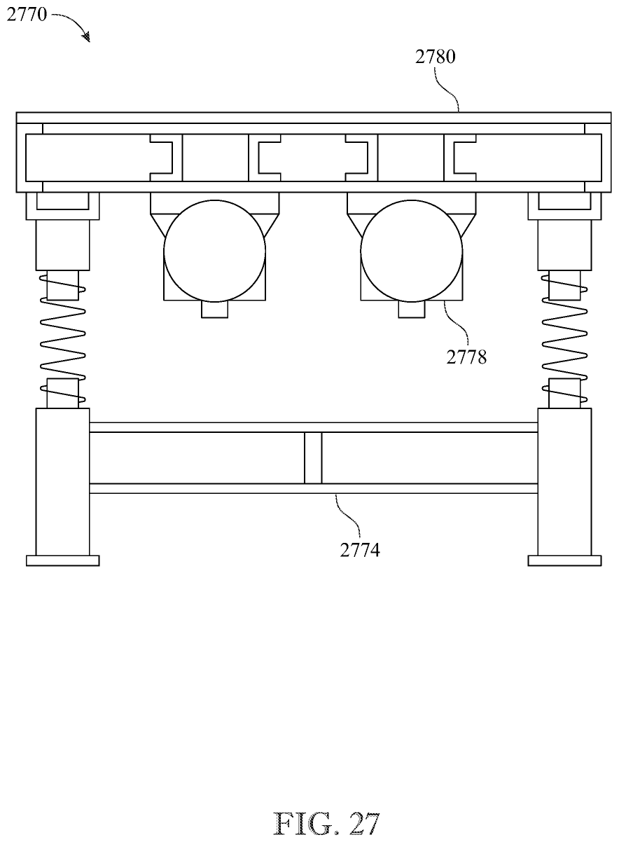

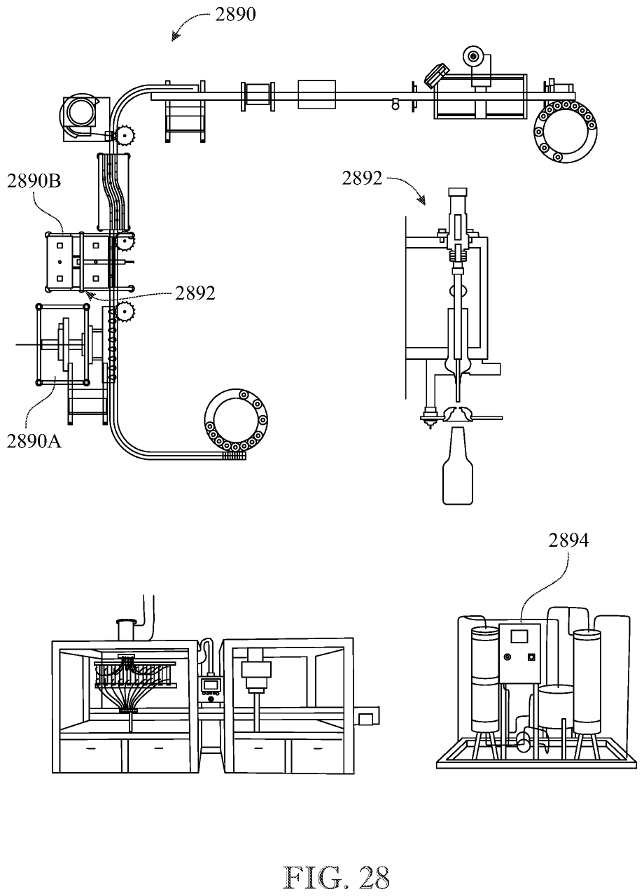

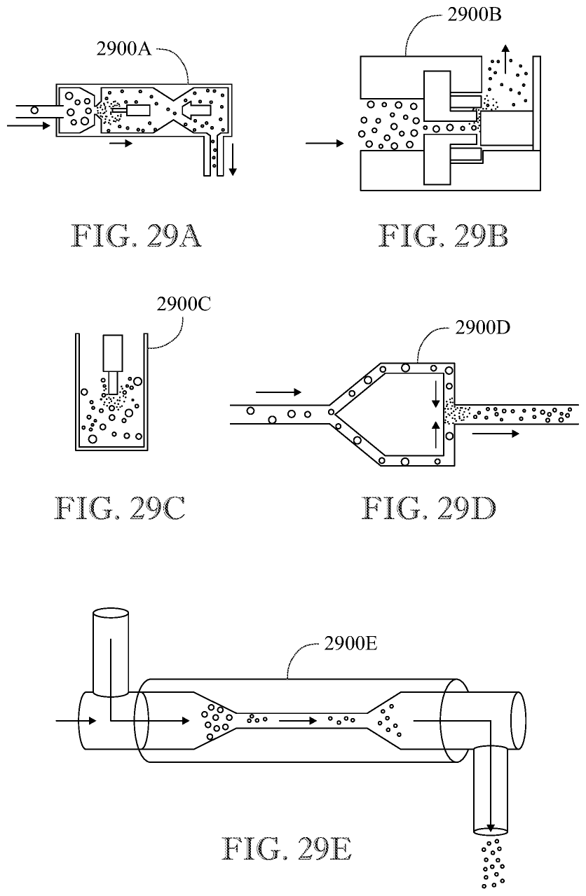

Referring now to FIGS. 24-26, a vibration table is shown, of the type described herein with reference to FIGS. 10, and 13-14. At FIG. 24, a vibration table 2370 is shown with a mixing or blending tank 2412. This type of mixing tank 2412 may be used with a vibration table 2470 as described herein with reference to FIG. 10, and FIGS. 13-14. As shown at FIG. 25, the vibration table 2570 is shown with an alternative type of mixing tank 2512. The vibration table is of the type generally used in hard rock and metal mining applications and PCB and e-waste processing applications. Its use in food and beverage methods is unprecedented. FIG. 26 shows a vibration table 2670 with a barrel 2614. FIG. 27 shows a vibration table stand 2774, a vibrator element 2778 and the upper table portion 2780.

A nonlimiting example of a vibration table is a MBMM LLC High Performance Shaker Table for hard rock and metal mining applications, and PCB and e-waste processing applications. In accordance with the present invention, a vibration table of the type used with concrete projects to eliminate air bubbles so they handle weight well may be used. A mixing tank would be placed on the vibration table, and the mixing tank would be filled with the liquid of choice to a particular level. Smoke would then be pumped into the tank until under a predetermined pressure, and the vibration table would be powered on to shake the liquid and smoke for the process of infusing the smoke. This process may be repeated until the desired outcome is achieved.

The blending tank may comprise a one-way valve inlet port where a smoke machine hose may be connected. In use, the tank may be filled between about 10%-90% of the tank volume with a liquid beverage of choice, as described herein. Then the smoke may be pumped into fill the headspace to a variable set pressure. The vibration table may be powered on to shake the contents of the tank, thus infusing the liquid with the smoke/vapor. The smoke will likely dissipate into the liquid fully, though a portion of the smoke may remain. The process may be repeated until the desired infusion level is achieved based on a profile of the liquid. The blending tank may be manually operated or may be operated by an automatic process. Once the liquid is infused with smoke; the liquid may pass through a series of filters to achieve desired results.

Various smoked materials such as smoked teas and other botanicals may be steeped in any suitable liquid such as RTD products, liquors, liqueurs, beer, cocktail mixers, oils, and liquids. Prior to steeping in the liquid, the tea leaves, botanicals, plant materials, grains, fruits, vegetables, or the like, may be smoked in a smoker using various types of wood or other organic materials such as botanicals, etc. to infuse them with the smoke scent and taste. This process can be repeated several times until a desired effect is achieved. The intended material may be soaked in water before and in between smoking sessions depending on desired results, materials, temperature, and humidity levels. The material may be stored in new or used wood barrels with water, spirits or other beverage liquids and aged until a desired result is achieved. The material may be smoked again once removed from the barrels to dry and enhance the smoke aroma and flavor.

The smoked material would then be placed into a steeping bag and then placed into a blending tank with the liquid to be smoked or smoke-infused. The time, temperature, and possible agitation or no agitation associated with the steeping will potentially affect the result and offers a range of depth for choice. Once the time of steeping is up, the infusion is complete. The product is ready to be bottled as is or may go through one or more additional smoking or smoke-infusion methods as described herein to provide an even deeper smoke flavor and scent.

In some embodiments, the present invention may also include shaking or blending to infuse smoke into RTD products, spirits, liqueurs, beer, cocktail mixers, oils, or other liquids. The shaking or blending may be effected using one or more of a shaker tank, a blending tank with an air stone, a blending tank with a built-in porous surface, a dual port fill to infuse smoke and/or vapor into RTD products, liquors, liqueurs, beverages, beer, cocktail mixers, oils and liquids, or combinations thereof. In some embodiments, instead of actual smoke, artificial smoke or smoke flavoring comprising natural flavors, artificial flavors, or combinations thereof, may be blended into a beverage.

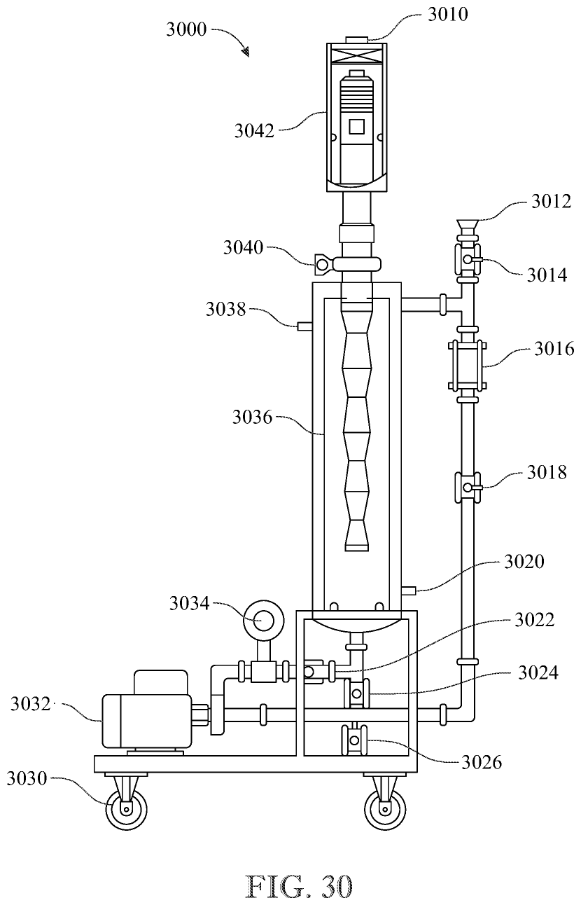

Referring now to FIG. 28, an example of a system according to the present invention which includes a bottling line 2890. The bottling line 2890 includes a smoke delivery inlet 2892, which may be incorporated into an existing filling nozzle or provided as a separate component located between a rinser 2890A and a filler 2890B of the bottling line. The bottling line 2890 may be modified to incorporate the smoke inlet line 2892 for the smoke to be pumped into the bottles by adding a section specifically to just have smoke injection ports that lower into the bottles and pump smoke for a time set by machine controls; or utilizing a filling line that fills the bottles with inert gas before product filling by routing the line from an inert gas tank to the smoke inlet line.

A nonlimiting example of an automatic bottling system for automatically bottling craft spirits which includes a rinser/filler, capper, and labeler into which a smoke inlet line may be incorporated is a Flexiblock brand custom linear filling system commercially available from IC Filling Systems.

In some embodiments, the system may comprise a dual port fill mechanism. The dual port fill mechanism may comprise a filling line modified to provide two ports configured to fill simultaneously. The two ports may comprise a first port configured for filling spirits, liquids, or the like, and a second port configured to fill smoke and/or vapor. The dual port fill mechanism may further comprise at least one one-way valve at a top portion configured to release pressure and excess smoke and/or vapor. The dual port fill mechanism may be semi-automatic or automated.

In some embodiments existing filling lines configured to pre-fill bottles with an inert gas, may be reconfigured to deliver smoke instead of the inert gas for smoking the bottle. A de-aerator and carbonator 2894 may be used. For example, a de-aerator and carbonator which has 1000 liters per hour capacity may be used, a nonlimiting example of which is commercially available from IC Filling Systems.

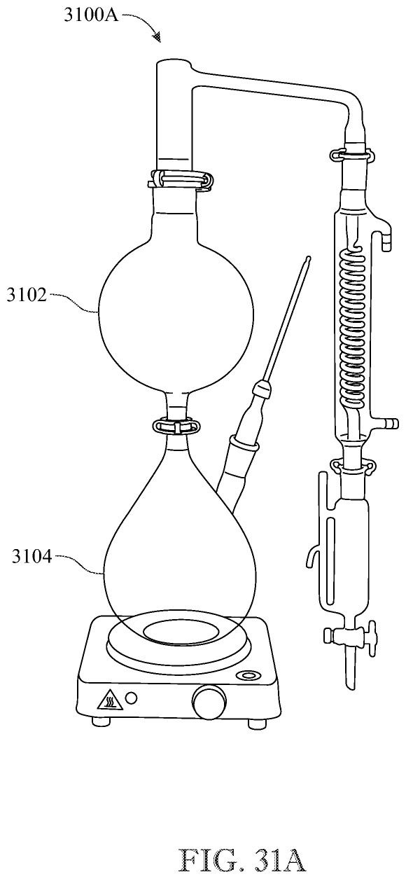

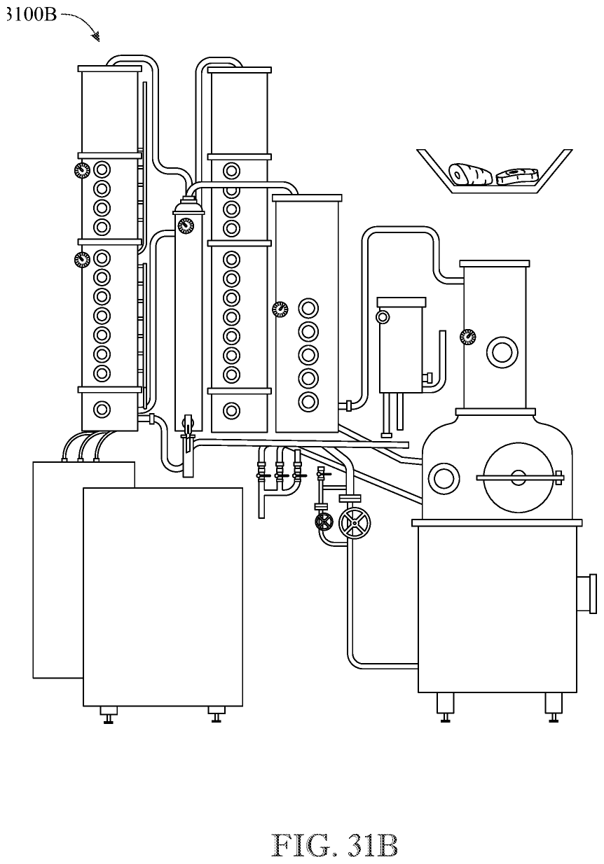

In some embodiments, the system may include a homogenizer. A homogenizing may be effected before, during and after smoking or smoke-infusing in accordance with the present invention. The ultrasonic homogenizers shown at FIGS. 29A-E and FIG. 30 may be incorporated in a system of the present invention and used before, during, in between or after any of the methods of infusing smoke or infusing smoked materials.

Referring to FIGS. 29A-E, in some embodiments, the system may include an ultra-sonic homogenizer or sonicator, 2900A, 2900B, 2900C, 2900D and 2900E. FIG. 29E shows a high pressure homogenizing not shown above but is more or less a different design for microdroplet homogenizing. FIG. 30 shows an ultrasonic homogenizer 3000 in greater detail, which comprises a vibrator air socket 3010, a material feed inlet 3012, a control valve of feed inlet 3014, a visible window 3016, a connector of vibrator 3018, a control valve of sample export 3020, a governor valve of feed flow rate 3022, a control valve of outlet 3024, a material outlet 3026, a universal wheel 3030, a material pump 3032, a flow meter 3034, a cooling water inlet 3036, a cooling water outlet 3038, an ultrasonic vibrator 3040, and a connector of vibrator 3042. The ultra-sonic homogenizer or sonicator may be used in producing smoked or smoke/vapor-infused products or other products. The ultra-sonic homogenizer or sonicator may be used during the blending and mixing of spirits, liqueurs, RTD, cocktail mixers, beer, and other liquid beverages. The ultra-sonic homogenizer or sonicator may be used following smoke/vapor infusion methods where tanks are utilized. The ultra-sonic homogenizer may comprise at least one probe capable of being placed in one or more of a blending tank and a mixing tank during the mixing and/or blending of an RTD, a spirit, a liqueur, a cocktail mixer, or another liquid beverage. The filling lines may be modified to provide this process post dual port injection.

Once a container is filled with a liquid beverage, the container would be advanced to the ultra-sonic homogenizer and a probe would be lowered into the containers and pulsed for the desired amount of time to achieve the desired level of homogenization. A liquid beverage may be passed through an ultra-sonic homogenizer machine that allows liquids to flow therethough. The ultra-sonic homogenizer machine may include a probe over which the liquids pass before returning to a blending, mixing, or holding tank. Using an ultra-sonic homogenizer breaks apart long chain molecules which may cause undesired traits in liquids such as burn in spirits and may be beneficially employed to create a smoother spirit. The use of an ultra-sonic homogenizer may occur before or after additionally filtering post-infusion. The use of an ultra-sonic homogenizer essentially makes the liquids nano emulsions.

In some embodiments, a beverage container may be manually treated with smoke and/or vapor, in a process using a permanently installed or portable smoke machine to fill containers with smoke and/or vapor. The containers may be at any safe location, such as on a pallet, in cases, or on a fill station or fill line. The containers may be filled immediately after being treated with smoke and/or vapor or may alternatively be corked or capped until the smoke has dissipated, and then filled. The hose from the smoke machine would have a nozzle tip installed thereon which would permit the tip to be inserted into the container and then filled to desired level.

Treatment of the container with smoke and/or vapor may be semi-automatic or automatic. For example, semi-automatic or automatic filling lines may be modified to include a section for treatment with smoke and/or vapor. The container may pass beneath a smoke/vapor injection port. The smoke/vapor injection port may be positioned just above the containers at a level set manually or automatically depending on the filling line. The smoke/vapor injection port may also be configured to be lowered into the container. The smoke/vapor will fill the container to a desired level. The smoke/vapor injection port may have a one-way valve to permit excess smoke/vapor to vent out. After treatment of the container with smoke and/or vapor, the containers may be capped and rested until the smoke/vapor fully dissipates or may be advanced down the line to be filled with smoke/vapor still in the container. These smoked/vapored containers could be used for any food or beverage products including RTD products, spirits, liqueurs, beer, cocktail mixers, oils, liquids, or the like.

The smoking and smoke-infusion methods described herein may be fully automated in the same way that processing of liquids is automated. The smoking and smoke-infusion system of the present invention may be configured to control the smoke/vapor aspects in the same way it controls the liquids. Parameters which may be controlled by the systems of the present invention may include time of fill, and pressure. Other parameters may be aspects of data for control of the automated system, depending on which system is used.

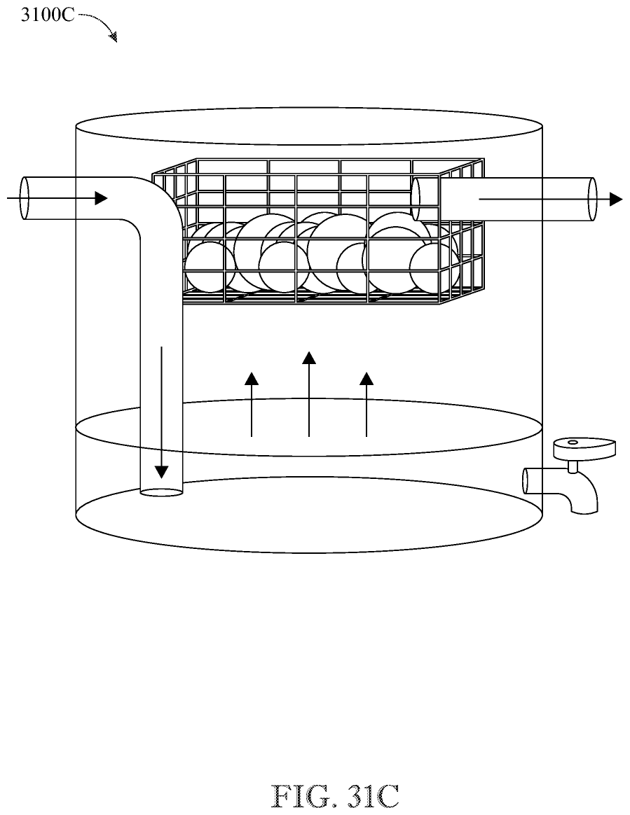

In some embodiments, distillation apparatuses may be incorporated into a system of the present invention. FIG. 31A shows a botanical still 3100A wherein the botanical or smoked material could be placed in an upper portion 3102, and a liquid such as water or spirits placed in the bottom 3104 and the material goes through a distillation process to contact the botanical or smoked material during the distillation to produce a distillation product comprising a botanical or smoked material extract. This method is similar to methods used in making Gin, in particular making compound Gin by extracting each botanical ingredient separately so that the extracts may later be blended in for a more precise flavor profile. FIGS. 31B and 31C show further examples of distillation apparatuses 3100B,3100C which may be incorporated in the system.

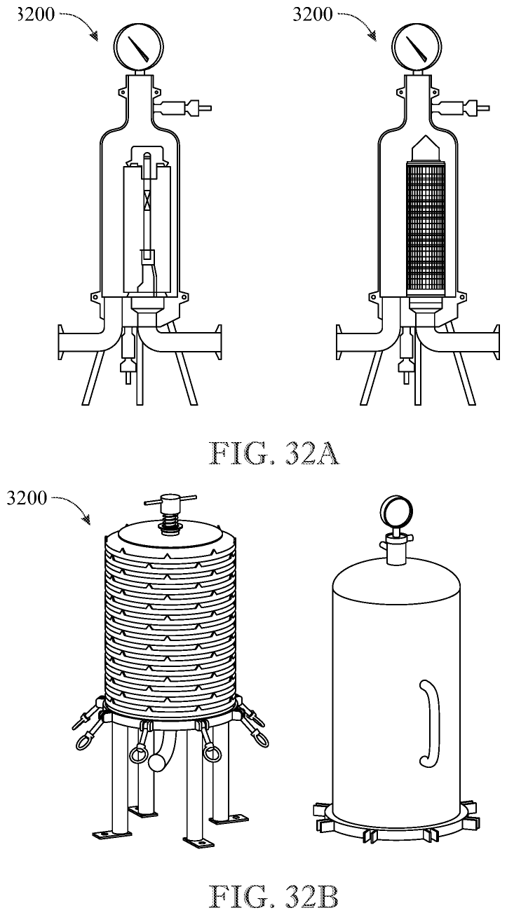

FIGS. 32A-B show a lenticular filter 3200 that may be used before and/or after any of the methods of smoke-infusion or infusion of smoked material products.

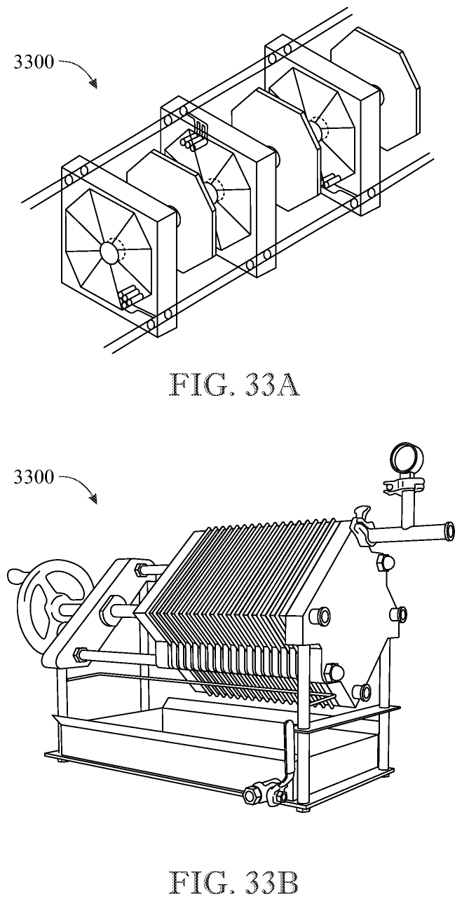

FIGS. 33A-B show additional filtration options for the system of the present invention by a filter press, with FIG. 33A providing an exploded view of a filter press type filter 3300 that may be used before and/or after any of the methods described herein.

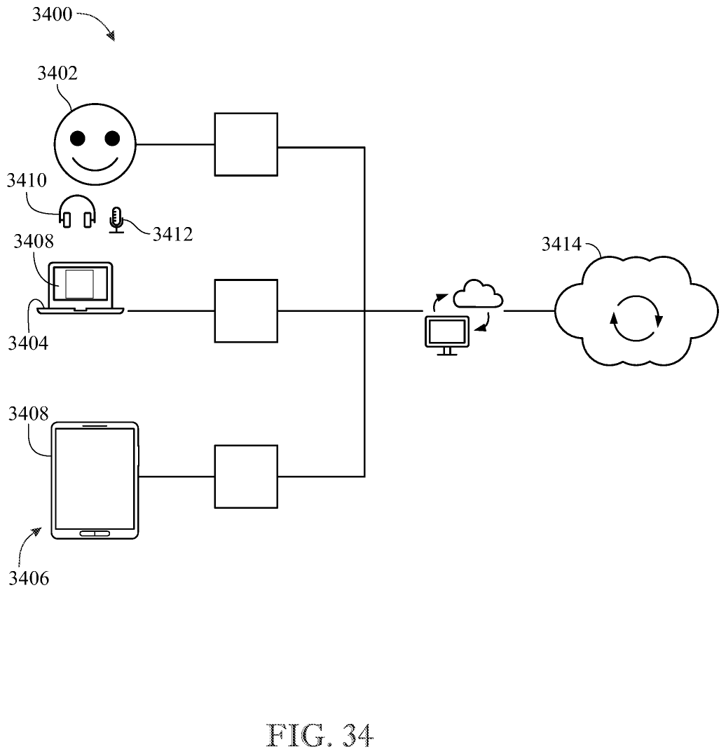

Referring now to FIG. 34, a schematic diagram of an exemplary computing system 3400 which may be used to operate or control a smoking or smoke-infusing system, apparatus or device as shown and described herein. The system 3400 may be used by at least one end-user 3402. The computing system 3400 may comprise a computing device 3404 in which a system software program 3408 is installed (the computing device 3404 is shown as a desktop or a notebook computer. The system 3400 may include a mobile computing system 3406 (in which the system software program 3408 is installed). In some embodiments, the system may further comprise an administrative system 3414 to which the computing devices 3404,3406 may wirelessly (or by wired connection) communicate through use of the system software program 3408. The computing device 3404,3406 may comprise any suitable device, nonlimiting examples of which may be an end-user's mobile phone or tablet. The end user 3402 may use a headphone device 3410 and a microphone 3412 which may be operatively connected to the computing device 3404,3406.

In some embodiments the method or methods described herein may be executed or carried out by a computing system including a tangible computer-readable storage medium, also described herein as a storage machine, which holds machine-readable instructions executable by a logic machine (i.e., a processor or programmable control device) to provide, implement, perform, and/or enact the methods, processes and/or tasks described herein. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described herein. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described herein to be executed or provided over a computer network. For example, the communication subsystem may be configured to enable the computing system to communicate with a plurality of personal computing devices.

The communication subsystem may include wired and/or wireless communication devices to facilitate networked communication. The described methods or processes may be executed, provided, or implemented for a user or one or more computing devices via a computer-program product such as via an application programming interface (API).

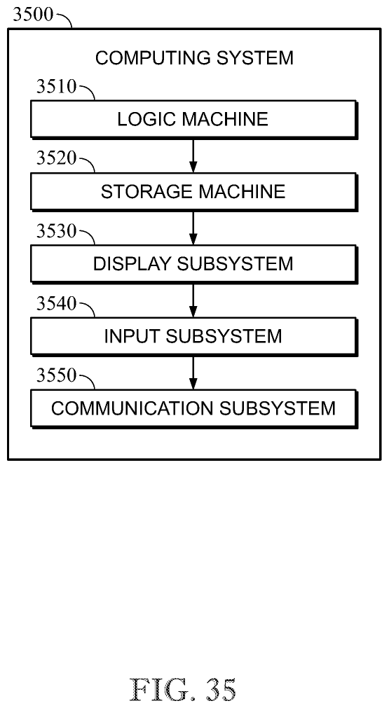

Referring now to FIG. 35, the illustration of FIG. 35 schematically presents a computing system that may represent a computing system of a smoking or smoke-infusing system, apparatus, or device in accordance with an embodiment of the present invention. In some embodiments the methods described herein may be executed on a computing system such as the computing system 3500 of FIG. 35. For example, the storage machine 3520 may hold instructions executable by the logic machine 3510 to provide the method to users. Display subsystem 3530 may display the various elements of the method to users. For example, the display subsystem 3530, the storage machine 3520, and the logic machine 3510 may be integrated such that the method may be executed while being displayed on a display screen. The input subsystem 3540 may receive user input from users to indicate the various choices or user inputs described herein. The described method may be executed, provided, or implemented to a user on one or more computing devices via a computer-program product such as via an application programming interface (API). FIG. 35 schematically shows a non-limiting exemplary embodiment of a computing system 3500 that can enact the method described herein. Computing system 3500 may be any appropriate computing device such as a personal computer, tablet computing device, gaming device or console, mobile computing device, etc. Computing system 3300 includes a logic machine 3510 and a storage machine 3520. Computing system 3500 may include a display subsystem 3530, input subsystem 3540, and communication subsystem 3550.

Logic machine 3510 may execute machine-readable instructions via one or more physical devices. For example, the logic machine 3510 may be configured to execute instructions to perform tasks for a computer program. The logic machine 3510 may include one or more processors to execute machine-readable instructions. The storage machine 3520 includes one or more physical devices configured to hold or store instructions executable by the logic machine 3510 to implement the method. When such methods and processes are implemented, the state of storage machine 3520 may be changed to hold different data. For example, the storage machine 3520 may include memory devices such as various hard disk drives or CD or DVD devices. The display subsystem 3530 may visually present data stored on the storage machine 3520. For example, the display subsystem 3530 may visually present data to form a graphical user interface (GUI). The input subsystem 3540 may be configured to connect and receive input from devices such as a mouse, keyboard, or gaming controller. The communication subsystem 3550 may be configured to enable the computing system 3500 to communicate with other computing devices. The communication subsystem 3550 may include wired and/or wireless communication devices to facilitate networked communication.

In summary, the present invention provides a method for smoking or smoke-infusing beverages for human consumption and smoked or smoke-infused beverages produced thereby. The method includes the steps of providing a beverage to be smoked or smoke-infused; providing a smoking or smoke-infusing system, apparatus, or device; operating the smoking or smoke-infusing system, apparatus, or device to provide a quantity of smoke or a smoke-infusion element; conveying the quantity of smoke or the smoke-infusion element to the beverage; and operating the smoking or smoke-infusing system, apparatus, or device to provide a smoked beverage or a smoke-infused beverage. The method may include providing a product container and operating the system, apparatus, or device to smoke the product container before adding the beverage; or to smoke or smoke-infuse the beverage in the product container. The method may also be used to smoke or smoke-infuse foods.

In some embodiments, the present invention provides a method for smoking or smoke-infusing beverages and smoked or smoke-infused beverages produced thereby. The method includes providing a predetermined quantity of a beverage to be smoked or smoke-infused; providing a smoking device or smoke-infusing device; placing the predetermined quantity of a beverage to be smoked in a suitable reaction vessel; placing the smoking device or the smoke-infusing device in the reaction vessel or in fluid communication with the reaction vessel; operating the smoking device or the smoke-infusing device to provide an effective amount of a white smoke substance, and to infuse the white smoke substance into the beverage, to provide a smoked beverage or a smoke-infused beverage; removing the smoked beverage or the smoke-infused beverage from the vessel; and providing a product container and placing the smoked beverage or the smoke-infused beverage in the product container.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A method for smoking or smoke-infusing a beverage for human consumption, the method comprising the steps of:
providing a beverage to be smoked or smoke-infused;
providing a smoking or smoke-infusing system, apparatus, or device;
operating the smoking or smoke-infusing system, apparatus, or device to provide a quantity of smoke or a smoke-infusion element;
conveying the quantity of smoke or the smoke-infusion element to the beverage; and
providing a smoked beverage or a smoke-infused beverage.

2. A smoked or smoke-infused beverage produced by the method of claim 1.

3. The method of claim 1 wherein the step of providing a beverage to be smoked or smoke-infused further comprises providing a reaction vessel and adding a predetermined quantity of the beverage to the reaction vessel; and the conveying step comprises conveying the quantity of smoke or a smoke-infusion element to the reaction vessel.

4. The method of claim 3 wherein the reaction vessel is a food or beverage product container.

5. The method of claim 3 further comprising:
removing the smoked beverage or the smoke-infused beverage from the vessel;
providing a product container or bottle; and
placing the smoked beverage or the smoke-infused beverage in the product container or bottle.

6. The method of claim 3 further comprising:
providing a product container or bottle,
adding the beverage to be smoked or smoke-infused to the product container or bottle, and
operating the smoking or smoke-infusing system, apparatus, or device to provide a smoked beverage or a smoke-infused beverage while the beverage is in the product container or bottle.

7. A method for smoking a liquor or preparing a smoke-infused alcoholic beverage for human consumption comprising the steps of:
providing a predetermined quantity of a beverage to be smoked or smoke-infused;
providing a smoking or smoke-infusing system; and
operating the system to smoke or infuse smoke in the predetermined quantity of the beverage.

8. The method of claim 6 wherein the system includes at least one smoked container, and at least one smoking apparatus.

9. The method of claim 7, wherein the at least one smoked container is selected from the group consisting of ready to drink (RTD) beverages, spirits, liqueurs, beer, wine, champagne and cocktail mixers, and other suitable foods or beverages.

10. The method of claim 7 wherein the smoking apparatus comprises:
a smoke machine configured to produce vapor or smoke, the smoke machine further comprising a variable temperature control, a variable-speed air pump and a high-speed exhaust fan;
a high-temperature food-grade hose operably connected to the smoke machine, the air pump and the exhaust fan, the hose configured to transfer vapor or smoke produced by the smoke machine to a desired location, the hose having a first proximal end attached to the smoke machine and a second distal end; and
a set of nozzles comprising a plurality of nozzles configured for removable installation on the second distal end of the hose, each nozzle of the set having a nozzle opening with a nozzle opening diameter, each nozzle having a different nozzle opening diameter.

11. A method for smoking or smoke-infusing a food or a beverage which comprises: providing a smoking device or smoke-infusing device;
placing a predetermined quantity of the food or the beverage to be smoked or smoke-infused in a suitable reaction vessel; and
placing the smoking device or the smoke-infusing device in the reaction vessel so the smoking device or the smoke-infusing device smokes or smoke-infuses the food or the beverage to provide a smoked or smoke-infused food or a smoked or smoke-infused beverage.

12. The method of claim 11 further comprising removing the smoked or smoke-infused food or the smoked or smoke-infused beverage from the vessel; and providing a product container and placing the smoked or smoke-infused food or smoked or smoke-infused beverage in the product container.

13. The method of claim 11, wherein the beverage is a distilled alcohol.

14. The method of claim 11, wherein the providing step is
providing a food; and following the placing step there is the further step of
removing the smoke component to provide the smoke-infused food.

15. The method of claim 11, wherein the second placing step comprises the infusing of the smoke component comprises infusing a white smoke substance into an alcoholic spirits container containing a predetermined quantity of an alcoholic beverage.

16. The method of claim 15, wherein the white smoke substance comprises smoke generated from the burning of organic material selected from the group consisting of tea leaves, botanicals, plant materials, grains, fruits, vegetables, and combinations thereof.

17. The method of claim 15, wherein the white smoke substance is infused into spirits in an individual container as the container is filled with spirits.

18. The method of claim 15, wherein the container itself is smoked separately and then filled with spirits.

19. The method of claim 11, wherein the second placing step includes the use of a vibration tank or barrel mounted on a vibration table.

20. The method of claim 11, wherein the second placing step includes the use of an ultra-sonic homogenizer or sonicator.
